(19) United States
(12) Patent Application Publication
(10) Pub. No.: US 2014/0086205 A1
(43) Pub. Date: Mar. 27, 2014

(54) BASE STATION AND METHOD OF ALLOCATING RADIO RESOURCE

(71) Applicant: Yuuki Nakasato, Ogaki-shi (JP)

(72) Inventor: Yuuki Nakasato, Ogaki-shi (JP)

(73) Assignee: KYOCERA CORPORATION, Kyoto-shi, Kyoto (JP)

(21) Appl. No.: 14/119,141

(22) PCT Filed: May 25, 2012
(86) PCT No.: PCT/JP2012/063520

§ 371 Date: Nov. 20, 2013

(30) Foreign Application Priority Data
May 27, 2011 (JP) 2011-119365

(51) Int. Cl. H04L 5/00

(52) U.S. Cl. CPC H04L 5/0037
USPC 370/330

(57) ABSTRACT

A radio resource allocating section sets a transmission frequency bandwidth of a known signal transmitted from each communication terminal communicating with a communication section to the smallest one of a plurality of bandwidths. The radio resource allocating section allocates, to a communication terminal which transmits the known signal in an uplink communication period included in a unit period, a downlink radio resource including a frequency band included in the transmission frequency band of the known signal in a frequency direction and including a plurality of downlink communication periods included in the unit period in a time direction as a use downlink radio resource.

### TECHNICAL FIELD

The present invention relates to a base station which controls the transmission directivity of a plurality of antennas.

### BACKGROUND ART

A variety of techniques related to radio communication have been hitherto proposed. A technique related to LTE (Long Term Evolution) is disclosed in Patent Literature 1, for example. LTE is referred to also as “E-UTRA”.

### CITATION LIST

### Patent Literature

Patent Literature 1: Japanese Patent Application Laid-Open No. 2008-099079

### SUMMARY OF INVENTION

### Technical Problem

In base stations for communication systems including LTE and the like, an adaptive array antenna system which adaptively controls the directivity of a plurality of antennas is used in some cases.

On the other hand, an improvement in performance of the base stations is desired.

In view of the foregoing, it is an object of the present invention to provide a technique capable of improving the performance of a base station which controls the transmission directivity of a plurality of antennas to communicate with communication terminals.

### Solution to Problem

A base station according to one aspect of the present invention is a base station for communicating with a communication terminal. The base station comprises: a communication section having a plurality of antennas and controlling the transmission directivity of the plurality of antennas, based on a known signal from a communication terminal, when performing downlink communication with the communication terminal; and a radio resource allocating section for allocating a use downlink radio resource which the communication section uses for the downlink communication with a communication terminal to the communication terminal and for allocating, to the communication terminal, a use uplink radio resource for the known signal which the communication terminal uses for the transmission of the known signal, wherein a unit period including a first uplink communication period in which a communication terminal transmits the known signal and a plurality of downlink communication periods in which downlink communication is performed appears repeatedly, the plurality of downlink communication periods appearing after the uplink communication period, wherein a plurality of bandwidths different in magnitude from each other are determined as a bandwidth that can be set as a transmission frequency bandwidth of the known signal, wherein the radio resource allocating section sets the transmission frequency bandwidth of the known signal transmitted from each communication terminal communicating with the communication section to the smallest one of the plurality of bandwidths, and wherein the radio resource allocating section allocates, to a communication terminal which transmits the known signal in the first uplink communication period included in the unit period, a downlink radio resource including a frequency band included in the transmission frequency band of the known signal in a frequency direction and including the plurality of downlink communication periods included in the unit period in a time direction as the use downlink radio resource.

A method of allocating a radio resource according to another aspect of the present invention is a method of allocating a radio resource to a communication terminal in a base station communicating with the communication terminal by using a plurality of antennas and controlling the transmission directivity of the plurality of antennas, based on a known signal from the communication terminal, when performing downlink communication with the communication terminal. The method comprises the steps of: (a) allocating a use downlink radio resource which the base station uses for the downlink communication with a communication terminal to the communication terminal; and (b) allocating, to the communication terminal, a use uplink radio resource for the known signal which the communication terminal uses for the transmission of the known signal, wherein a unit period including an uplink communication period in which the communication terminal transmits the known signal and a plurality of downlink communication periods in which downlink communication is performed appears repeatedly, the plurality of downlink communication periods appearing after the uplink communication period, wherein a plurality of bandwidths different in magnitude from each other are determined as a bandwidth that can be set as a transmission frequency bandwidth of the known signal, wherein the transmission frequency bandwidth of the known signal transmitted from each communication terminal communicating with the base station is set to the smallest one of the plurality of bandwidths in the step (b), and wherein a downlink radio resource including a frequency band included in the transmission frequency band of the known signal in a frequency direction and including the plurality of downlink communication periods included in the unit period in a time direction is allocated as the use downlink radio resource to a communication terminal which transmits the known signal in the uplink communication period included in the unit period in the step (a).

### Advantageous Effects of Invention

According to the present invention, the performance of the base station is improved.

These and other objects, features, aspects and advantages of the present invention will become more apparent from the following detailed description of the present invention when taken in conjunction with the accompanying drawings.

### BRIEF DESCRIPTION OF DRAWINGS

FIG. 1 is a diagram showing a configuration of a communication system according to an embodiment of the present invention.

FIG. 2 is a diagram showing a configuration of a base station according to the embodiment of the present invention.

FIG. 3 is a diagram showing a configuration of a TDD frame.

FIG. 4 is a table showing the types of configurations of the TDD frame.

FIG. 5 is a diagram showing the details of the configuration of the TDD frame.

FIG. 6 is a diagram showing the frequency hopping of an SRS transmittable band.

FIG. 7 is a diagram showing SRS0 and SRS1.

FIG. 8 is a diagram showing a plurality of uplink radio resources for SRS.

FIG. 9 is a diagram showing the frequency hopping of the frequency bands of allocatable uplink radio resources for SRS.

FIG. 10 is a diagram showing the frequency hopping of an SRS band.

FIG. 11 is a diagram showing the frequency hopping of an SRS band.

FIG. 12 is a diagram showing the operation of the communication system.

FIG. 13 is a diagram illustrating a method of allocating use downlink radio resources to communication terminals in a base station.

FIG. 14 is a diagram illustrating the method of allocating the use downlink radio resources to the communication terminals in the base station.

FIG. 15 is a diagram illustrating the method of allocating the use downlink radio resources to the communication terminals in the base station.

FIG. 16 is a diagram showing an example of the allocation of the use downlink radio resources to the communication terminals in the base station.

FIG. 17 is a diagram illustrating beamforming and null steering in the base station.

FIG. 18 is a diagram illustrating the beamforming and the null steering in the base station.

FIG. 19 is a diagram showing an example of the allocation of the use downlink radio resources to the communication terminals in the base station.

FIG. 20 is a diagram showing an example of the allocation of use uplink radio resources for SRS and use downlink radio resources to the communication terminals in a comparable base station.

FIG. 21 is a table showing the amounts of use downlink radio resources allocated to the communication terminals in the base station.

FIG. 22 is a table showing the amounts of use downlink radio resources allocated to the communication terminals in the comparable base station.

FIG. 23 is a diagram showing an example of the allocation of the use uplink radio resources for SRS and the use downlink radio resources to the communication terminals in the comparable base station.

FIG. 24 is a diagram showing an example of the allocation of the use downlink radio resources to the communication terminals in the base station.

### DESCRIPTION OF EMBODIMENTS

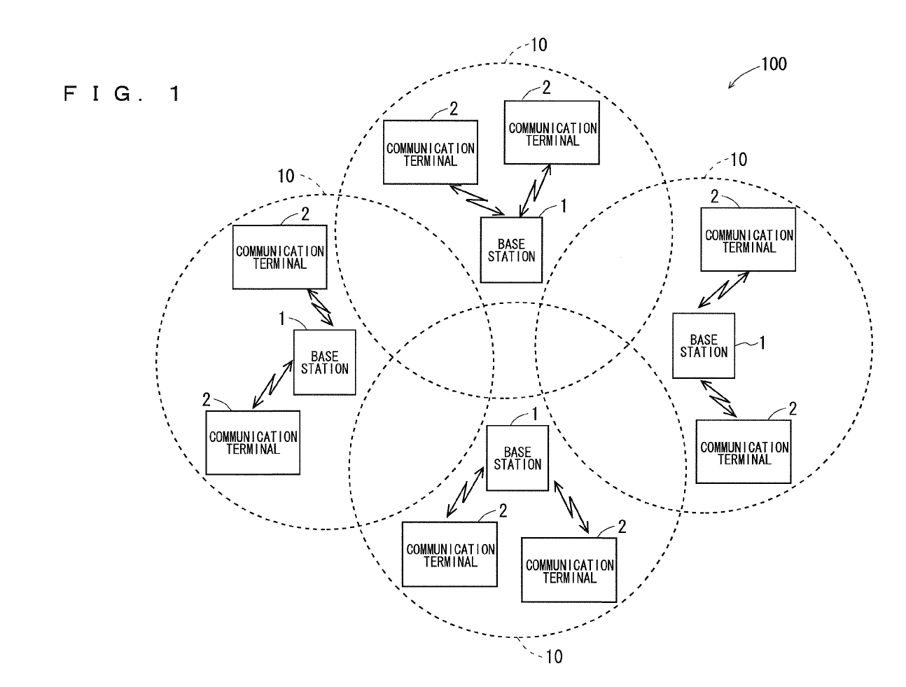

FIG. 1 is a diagram showing a configuration of a communication system 100 according to an embodiment of the present embodiment. The communication system 100 is, for example, LTE in which a TDD (Time Division Duplexing) system is adopted as a duplex system, and includes a plurality of base stations 1. Each of the base stations 1 communicates with a plurality of communication terminals 2. In LTE, an OFDMA (Orthogonal Frequency Divisiultiple Access) system is used for downlink communication, and an SC-FDMA (Single Carrier-Frequency Division Multiple Access) system is used for uplink communication. Thus, the OFDMA system is used for transmission from the base stations 1 to the communication terminals 2, and the SC-FDMA system is used for transmission from the communication terminals 2 to the base stations 1. An OFDM (Orthogonal Frequency Division Multiplexing) signal in which a plurality of subcarriers orthogonal to each other are combined together is used for communication between the base stations 1 and the communication terminals 2.

As shown in FIG. 1, each of the base stations 1 has a service area 10 which partially overlaps the service areas 10 of its neighboring base stations 1. In FIG. 1, there are only two or three neighboring base stations 1 for each of the base stations 1 because only four base stations 1 are shown. In actuality, there are six neighboring base stations 1, for example, for each of the base stations 1 in some cases.

The plurality of base stations 1 are connected to a network not shown, and are capable of communicating with each other via the network. A server device not shown is connected to the network, and each of the base stations 1 is capable of communicating with the server device via the network.

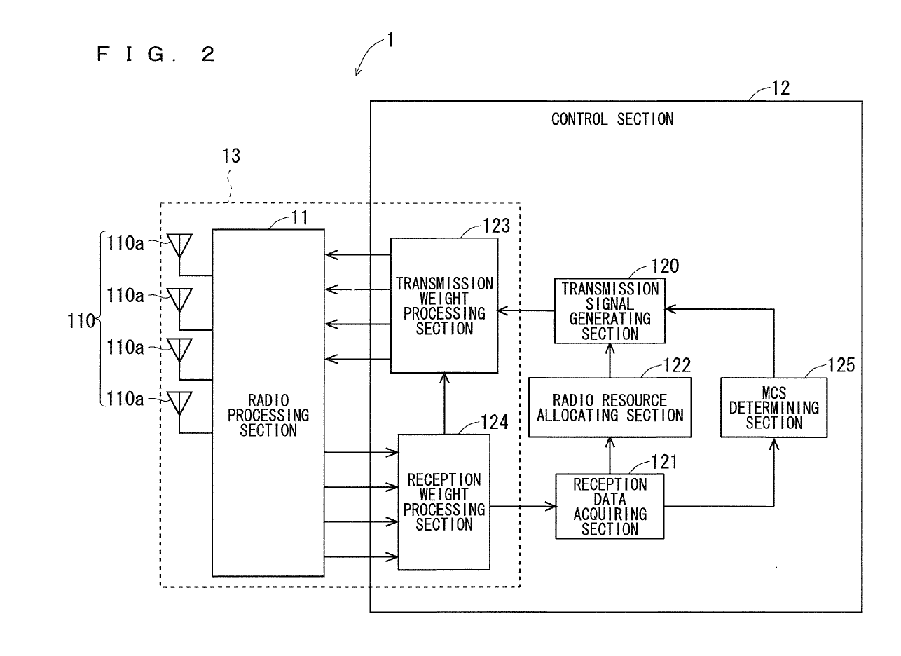

FIG. 2 is a diagram showing a configuration of each base station 1 according to the embodiment of the present invention. Such a base station 1 is capable of communicating with a plurality of communication terminals 2 at the same time by individually allocating radio resources identified by two-dimensions comprised of a time axis and a frequency axis to the communication terminals 2. The base station 1 includes an array antenna as transmitting and receiving antennas, and is capable of controlling the directivity of the array antenna by using an adaptive array antenna system.

As shown in FIG. 2, the base station 1 includes a radio processing section 11, and a control section 12 for controlling the radio processing section 11. The radio processing section 11 includes an array antenna 110 comprised of a plurality of antennas 110a. The radio processing section 11 performs an amplification process, down-converting, an A/D conversion process and the like on each of a plurality of reception signals received by the antenna array 110 to generate and output a plurality of baseband reception signals.

The radio processing section 11 also performs a D/A conversion process, up-converting, an amplification process and the like on each of a plurality of baseband transmission signals generated by the control section 12 to generate a plurality of carrier-band transmission signals. The radio processing section 11 then inputs the generated carrier-band transmission signals to the plurality of antennas 110a constituting the array antenna 110. Thus, the transmission signals are transmitted from the antennas 110a by radio.

The control section 12 includes a CPU (Central Processing Unit), a DSP (Digital Signal Processor), a memory and the like. In the control section 12, the CPU and the DSP execute programs stored in the memory, so that a plurality of functional blocks are formed which include a transmission signal generating section 120, a reception data acquiring section 121, a radio resource allocating section 122, a transmission weight processing section 123, a reception weight processing section 124, an MCS determining section 125, and the like.

The MCS determining section 125 determines an MCS (Modulation and Coding Scheme) for application to a transmission signal which the base station 1 transmits to a communication terminal 2. The MCS represents a combination of a modulation scheme such as QPSK (Quadrature Phase Shift Keying) and 16QAM (Quadrature Amplitude Modulation), and a code rate of an error correcting code. The MCS determining section 125 determines the MCS for application to the transmission signal to be transmitted to a communication terminal 2, based on downlink transmission channel characteristics (radio characteristics) between the base station 1 and the communication terminal 2 in a frequency band of the transmission signal.

The transmission signal generating section 120 generates transmission data for transmission to a communication terminal 2 for communication therewith. The transmission data includes control data and user data. Then, the transmission signal generating section 120 generates baseband transmission signals including the generated transmission data, based on the MCS determined by the MCS determining section 125. The generated transmission signals are equal in number to the antennas 110a constituting the array antenna 110.

The transmission weight processing section 123 assigns a plurality of transmission weights for controlling the transmission directivity of the array antenna 110 respectively to the plurality of transmission signals generated in the transmission signal generating section 120. The transmission weight processing section 123 performs an inverse discrete Fourier transform (IDFT) and the like on the plurality of transmission signals to which the respective transmission weights are assigned, and thereafter outputs the plurality of transmission signals to the radio processing section 11.

The reception weight processing section 124 performs a discrete Fourier transform (DFT) on the plurality of reception signals inputted from the radio processing section 11, and thereafter assigns a plurality of reception weights for controlling the reception directivity of the array antenna 110 respectively to the plurality of reception signals. Then, the reception weight processing section 124 combines the plurality of reception signals to which the respective reception weights are assigned together to form a new reception signal (referred to hereinafter as a “combined reception signal”).

The reception data acquiring section 121 performs an inverse discrete Fourier transform, a demodulation process and the like on the combined reception signal generated in the reception weight processing section 124 to acquire the control data and the user data included in the combined reception signal.

The radio processing section 11, the transmission weight processing section 123 and the reception weight processing section 124 in the base station 1 according to the present embodiment constitute a communication section 13 for communicating with the plurality of communication terminals 2 while adaptively controlling the directivity of the array antenna 110. When communicating with the communication terminals 2, the communication section 13 controls the reception directivity and the transmission directivity of the array antenna 110. Specifically, the communication section 13 adjusts the reception weights by which the reception signals are multiplied in the reception weight processing section 124 to thereby set the beam and null of the reception directivity of the array antenna 110 in various directions. Also, the communication section 13 adjusts the transmission weights by which the transmission signals are multiplied in the transmission weight processing section 123 to thereby set the beam and null of the transmission directivity of the array antenna 110 in various directions. The transmission weights may be determined from the reception weights, and the reception weights may be determined based on known signals from the communication terminals 2.

The radio resource allocating section 122 determines a communication terminal 2 which performs downlink communication of data, and allocates a downlink radio resource (referred to hereinafter as a “use downlink radio resource”) for use in the downlink communication of data with the communication terminal 2 to the communication terminal 2. The transmission signal generating section 120 generates a transmission signal including data to be transmitted to the communication terminal 2, based on the use downlink radio resource allocated to the communication terminal 2 by the radio resource allocating section 122, and inputs the transmission signal to the transmission weight processing section 123 at the time based on the use downlink radio resource. Thus, the transmission signal including the data to be transmitted to the communication terminal 2 is transmitted from the communication section 13 by using the use downlink radio resource allocated to the communication terminal 2. The transmission signal generating section 120 generates and outputs a transmission signal including the control data for notifying the communication terminal 2 about the use downlink radio resource allocated to the communication terminal 2 by the radio resource allocating section 122. This allows the communication terminal 2 to know the use downlink radio resource for use in the transmission of data thereto, thereby receiving the data from the base station 1 thereto appropriately.

The radio resource allocating section 122 also determines a communication terminal 2 which performs uplink communication of data, and allocates an uplink radio resource (referred to hereinafter as a “use uplink radio resource”) for use in the uplink communication of data with the communication terminal 2 to the communication terminal 2. The transmission signal generating section 120 generates and outputs a transmission signal including control data for notifying the communication terminal 2 about the use uplink radio resource allocated to the communication terminal 2 by the radio resource allocating section 122. This allows the communication terminal 2 to know the use uplink radio resource for use in the transmission of data to the base station 1, thereby transmitting the data to the base station 1 by radio by using the use uplink radio resource.

Further, the radio resource allocating section 122 allocates an uplink radio resource (referred to hereinafter as a “use uplink radio resource for SRS”) which a communication terminal 2 uses when transmitting a sounding reference signal (SRS) that is a known signal to be described later to the communication terminal 2. The transmission signal generating section 120 generates and outputs a transmission signal including control data for notifying the communication terminal 2 about the use uplink radio resource for SRS allocated to the communication terminal 2 by the radio resource allocating section 122. This allows the communication terminal 2 to know the use uplink radio resource for SRS for use in the transmission of the SRS to the base station 1, thereby transmitting the SRS to the base station 1 by radio by using the use uplink radio resource for SRS.

<Configuration of TDD Frame>

Next, a TDD frame 300 for use between the base station 1 and the communication terminals 2 will be described. The TDD frame 300 is identified by two-dimensions comprised of a time axis and a frequency axis. The frequency bandwidth (system bandwidth) of the TDD frame 300 is 10 MHz, for example. The time length of the TDD frame 300 is 10 ms. The base station 1 determines use uplink radio resources, use downlink radio resources and use uplink radio resources for SRS for allocation to each of the communication terminals 2 from the TDD frame 300.

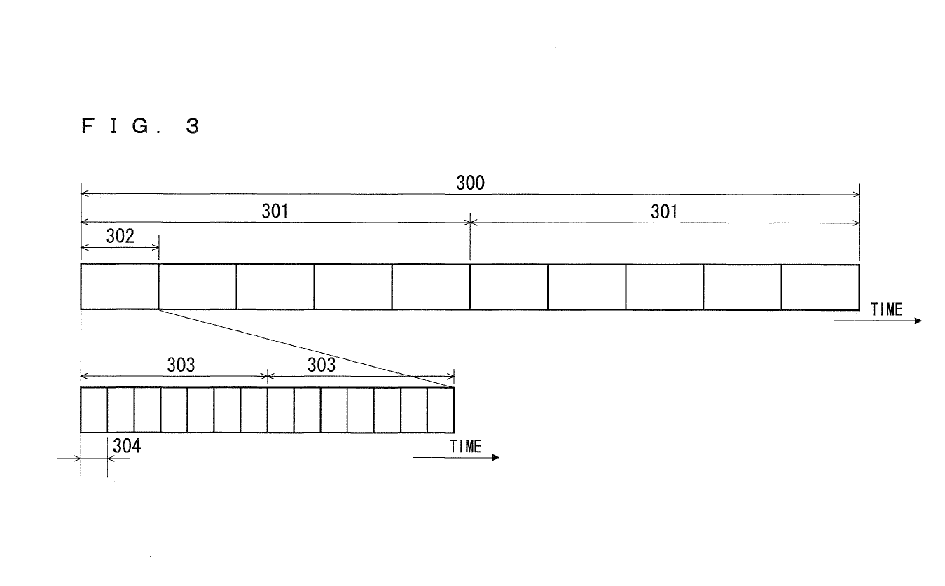

FIG. 3 is a diagram showing a configuration of the TDD frame 300. As shown in FIG. 3, the TDD frame 300 is comprised of two half frames 301. Each of the half frames 301 is comprised of five sub-frames 302. That is, the TDD frame 300 is comprised of ten sub-frames 302. The time length of each of the sub-frames 302 is 1 ms. The ten sub-frames 302 constituting the TDD frame 300 are hereinafter referred to as zeroth to ninth sub-frames 302 in order from the leading end in some cases. The time length of the single TDD frame 300 is referred to as “one frame time”, and the time length of consecutive sub-frames 302 is referred to as a “half frame time”.

Each of the sub-frames 302 is comprised of two slots 303 arranged in the time direction. Each of the slots 303 is comprised of seven symbol periods 304. Thus, each of the sub-frames 302 includes 14 symbol periods 304 arranged in the time direction. Such a symbol period 304 serves as one symbol period for an OFDM symbol in the downlink communication of the OFDMA system, and serves as one symbol period for a DFTS (Discrete Fourier Transform Spread)-OFDM symbol in the uplink communication of the SC-FDMA system.

The TDD frame 300 having the aforementioned configuration includes sub-frames 302 for uplink communication only, and sub-frames 302 for downlink communication only. A sub-frame 302 for uplink communication only is referred to as an “uplink sub-frame 302” and a sub-frame 302 for downlink communication only is referred to as a “downlink sub-frame 302” hereinafter. The communication terminals 2 transmit data to the base station 1 in the uplink sub-frames 302, and the base station 1 transmits data to the communication terminals 2 in the downlink sub-frames 302.

In LTE, a region (radio resource) of the TDD frame 300 which includes a frequency bandwidth of 180 kHz in the frequency direction and includes seven symbol periods 304 (one slot 303) in the time direction is referred to as a “resource block (RB).” The resource block includes 12 subcarriers. When allocating the use uplink radio resources to a communication terminal 2 or when allocating the use downlink radio resources to a communication terminal 2, the radio resource allocating section 122 allocates the use uplink radio resources or the use downlink radio resources to the communication terminal 2 in units of two consecutive resource blocks, i.e. in units of one sub-frame 302, in the time direction and in units of one resource block in the frequency direction. When resource blocks are allocated in the frequency direction to a communication terminal 2 in the uplink sub-frames 302, resource blocks consecutive in the frequency direction are allocated to the communication terminal 2 because the SC-FDMA system is used in the uplink communication. The term “RB” shall represent the frequency band of a resource block hereinafter.

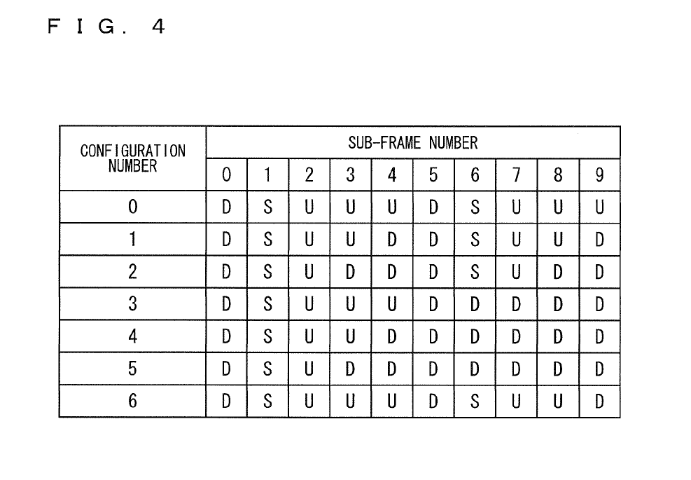

In LTE, seven types of configurations of the TDD frame 300 are specified which differ from each other in combination of the uplink sub-frames 302 and the downlink sub-frames 302. FIG. 4 is a table showing the seven types of configurations.

As shown in FIG. 4, zeroth to sixth configurations of the TDD frames 300 are specified in LTE. In the communication system 100, one of the seven types of configurations is used. In FIG. 4, the sub-frames 302 denoted by “D” mean the downlink sub-frames 302, and the sub-frames 302 denoted by “U” mean the uplink sub-frames 302. Also, the sub-frames 302 denoted by “S” mean sub-frames 302 in which switching from the downlink communication to the uplink communication is performed in the communication system 100. The sub-frames 302 of this type are referred to as “special sub-frames 302”.

For example, in the TDD frame 300 having the zeroth configuration, the zeroth and fifth sub-frames 302 are the downlink sub-frames 302, the second to fourth sub-frames 302 and the seventh to ninth sub-frames 302 are the uplink sub-frames 302, and the first and sixth sub-frames 302 are the special sub-frames 302. Also, in the TDD frame 300 having the fourth configuration, the zeroth sub-frame 302 and the fourth to ninth sub-frames 302 are the downlink sub-frames 302, the second and third sub-frames 302 are the uplink sub-frames 302, and the first sub-frame 302 is the special sub-frame 302. The TDD frame 300 having the first configuration, for example, shall be used in the communication system 100 according to the present embodiment.

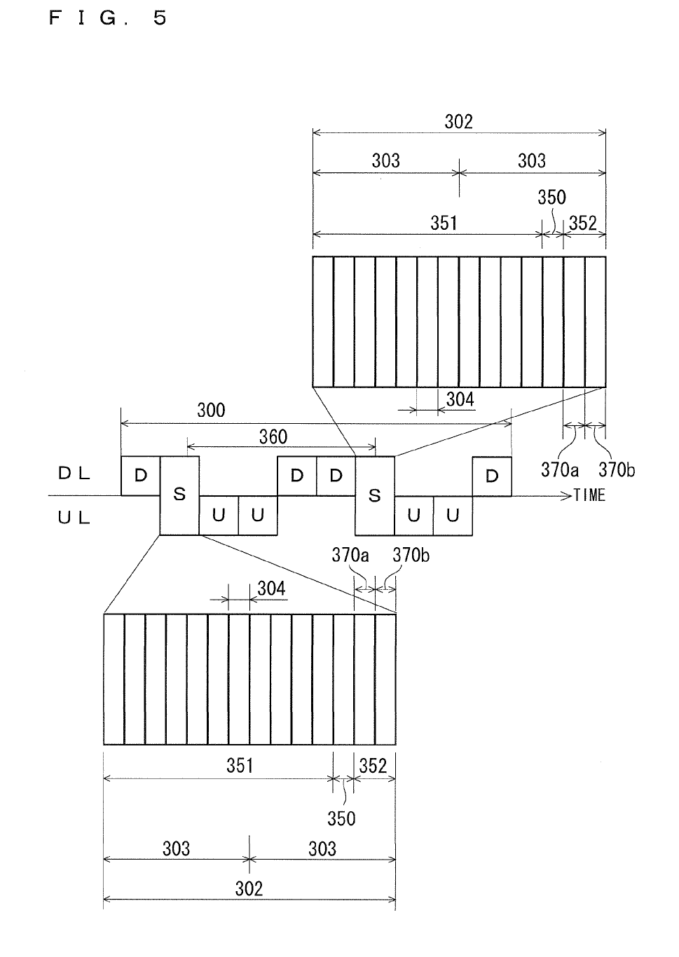

FIG. 5 is a diagram showing the details of the configuration of the TDD frame 300 having the first configuration. As shown in FIG. 5, each special sub-frame 302 includes a downlink pilot time slot (DwPTS) 351, a guard time (GP) 350, and an uplink pilot time slot (UpPTS) 352. The guard time 350 is a no-signal time period required for the switching from the downlink communication to the uplink communication, and is not used for communication.

A plurality of types of combinations of time lengths of the downlink pilot time slot 351, the guard time 350 and the uplink pilot time slot 352 are specified in LTE. In the example of FIG. 5, the time length of the downlink pilot time slot 351 is set to 11 symbol periods 304, and the time length of the uplink pilot time slot 352 is set to 2 symbol periods 304.

In the communication system 100 according to the present embodiment, the downlink communication is allowed to be performed not only in the downlink sub-frame 302 but also in the downlink pilot time slot 351 of the special sub-frame 302. Also in this communication system 100, the uplink communication is allowed to be performed not only in the uplink sub-frame 302 but also in the uplink pilot time slot 352 of the special sub-frame 302.

In the present embodiment, the base station 1 transmits data to a communication terminal 2 in each of the symbol periods 304 of the downlink pilot time slot 351. Each of the communication terminals 2 transmits the known signal referred to as the SRS in one or both of the two symbol periods 304 of the uplink pilot time slot 352. The SRS is comprised of a plurality of complex symbols which modulate a plurality of subcarriers. In the present embodiment, the SRS transmitted in the uplink pilot time slot 352 is used for calculation of the transmission weight. In other words, the communication section 13 in the base station 1 is capable of controlling the transmission directivity of the array antenna 110, based on the SRS transmitted from the communication terminals 2 in the uplink pilot time slot 352. The control of the transmission directivity of the array antenna 110 is referred to as “array transmission control” hereinafter.

It should be noted that the SRS can be transmitted in the last symbol period 304 of the uplink sub-frame 302. In other words, the communication terminals 2 are able to transmit data in symbol periods 304 other than the last symbol period 304 of the uplink sub-frame 302, and to transmit the SRS in the last symbol period 304. For the array transmission control, the SRS transmitted in the last symbol period 304 of the uplink sub-frame 302 may be used, but the SRS transmitted in the uplink pilot time slot 352 shall be used in the present embodiment. The SRS shall mean the SRS transmitted using the uplink pilot time slot 352 hereinafter unless otherwise specified. The single transmission of the SRS means the transmission of the SRS in a single symbol period 304 hereinafter. A leading one of the symbol periods 304 and a trailing one thereof included in the uplink pilot time slot 352 in which the communication terminals 2 are able to transmit the SRS are referred to hereinafter as a “first uplink communication period for SRS 370a” and a “second uplink communication period for SRS 370b”, respectively. The first uplink communication period for SRS 370a and the second uplink communication period for SRS 370b are referred to as “uplink communication periods for SRS” if the periods 370a and 370b need not particularly be identified.

A time period from the leading end of the first uplink communication period for SRS 370a of a special sub-frame 302 to the leading end of the first uplink communication period for SRS 370a of the next special sub-frame 302 is referred to as a “unit period 360” hereinafter. The allocation of the radio resources such as the use downlink radio resources to the communication terminals 2 is on the basis of the unit period 360. The unit period 360 appears repeatedly in this communication system 100.

In the present embodiment, each of the communication terminals 2 which communicates with the base station 1 transmits the SRS at least once in each unit period 360, for example, based on the allocation of the use uplink radio resources for SRS by the radio resource allocating section 122. That is, each of the communication terminals 2 which communicates with the base station 1 transmits the SRS in one or both of the first uplink communication period for SRS 370a and the second uplink communication period for SRS 370b included in each unit period 360. The process of transmitting the SRS once in each unit period 360 from a communication terminal 2 is referred to as a “5-ms cycle transmission” because the unit period 360 has a length of 5 ms. Also, the process of transmitting the SRS twice in each unit period 360 from a communication terminal 2 is referred to as the “shortest cycle transmission”.

In LTE, it is possible for the base station 1 to allocate the use uplink radio resources for SRS to a communication terminal 2 so that the communication terminal 2 transmits the SRS once in each plurality of unit periods 360. However, only the 5-ms cycle transmission and the shortest cycle transmission are used in the present embodiment.

<Frequency Hopping of SRS Transmittable Band>

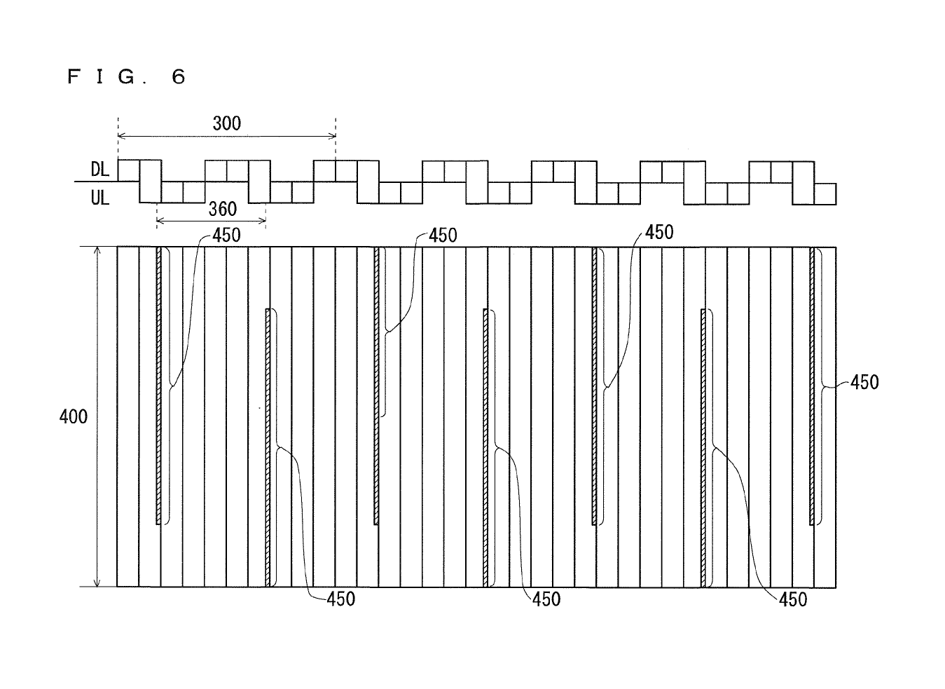

In the present communication system 100, a frequency band 450 (referred to hereinafter as an “SRS transmittable band 450”) which the communication terminals 2 can use for the transmission of the SRS is frequency-hopped for each of the unit periods 360. FIG. 6 is a diagram showing the frequency hopping of the SRS transmittable band 450.

As shown in FIG. 6, the SRS transmittable band 450 is disposed alternately on a high-frequency side and on a low-frequency side in a system band 400 for each of the unit periods 360. Thus, a high-frequency end portion or a low-frequency end portion of the system band 400 in each unit period 360 is a band unusable for the transmission of the SRS. This band is referred to as an “SRS untransmittable band” hereinafter. Each base station 1 is not allowed to allocate uplink radio resources including a frequency band included in the SRS untransmittable band in the frequency direction as the use uplink radio resources for SRS to the communication terminals 2.

The base stations 1 have the same SRS untransmittable band. Thus, the SRS untransmittable band which a certain base station 1 is not allowed to allocate to the communication terminals 2 for the transmission of the SRS coincides in each unit period 360 with the SRS untransmittable band which a neighboring base station 1 positioned in the neighborhood of the certain base station 1 is not allowed to allocate to the communication terminals 2 for the transmission of the SRS.

When the system bandwidth is 10 MHz as in the present embodiment, the system band 400 includes 50 RBs. In this case, the bandwidth of the SRS transmittable band 450 is a frequency bandwidth corresponding to 40 RBs, and the bandwidth of the SRS untransmittable band is a frequency bandwidth corresponding to 10 RBs. Numbers 0 to 49 are assigned to 50 RBs arranged in the frequency direction in order of increasing frequency hereinafter. These numbers are used in some cases to illustrate the operation of the communication system 100.

<Configuration of SRS>

Two types of SRSs identified by a parameter k_{TC} referred to as “transmissionComb” are specified in the communication system 100 according to the present embodiment. The parameter k_{TC} can take a value “0” or “1”. Subcarriers SC0 for use in the transmission of the SRS (referred to hereinafter as “SRS0”) identified by the parameter k_{TC}=0 are not successively disposed but are disposed in the form of comb teeth in the frequency direction. In other words, the carrier frequency of the SRS0 is disposed in the form of comb teeth in the frequency direction. Likewise, subcarriers SC1 for use in the transmission of the SRS (referred to hereinafter as “SRS1”) identified by the parameter k_{TC}=1 are disposed in the form of comb teeth in the frequency direction. When the SRS0 and the SRS1 are transmitted in the same frequency band, the plurality of subcarriers SC0 for use in the transmission of the SRS0 and the plurality of subcarriers SC1 for use in the transmission of the SRS1 are disposed alternately in the frequency direction. Thus, the carrier frequency of the SRS0 and the carrier frequency of the SRS 1 do not overlap each other in the frequency direction.

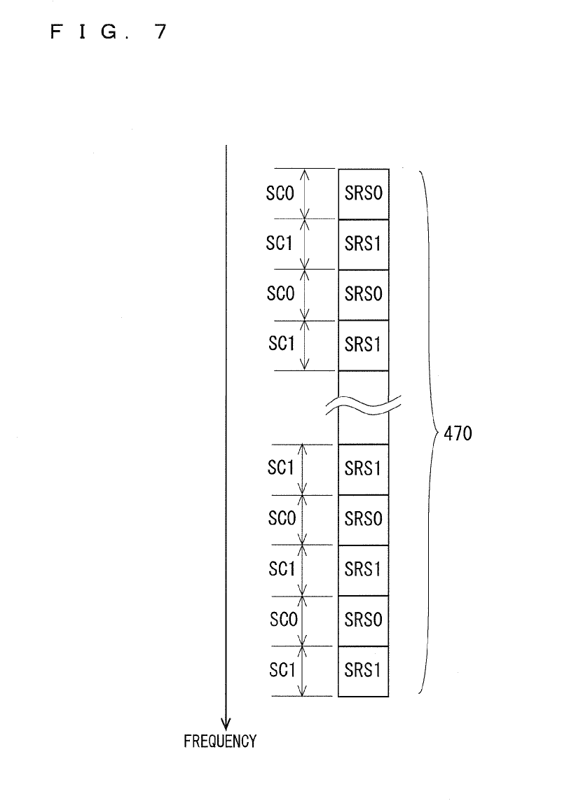

FIG. 7 shows that both the SRS0 and the SRS 1 are transmitted in a certain frequency band 470. As shown in FIG. 7, the subcarriers SC0 for use in the transmission of the SRS0 are disposed at every other subcarrier position in the frequency direction. Likewise, the subcarriers SC1 for use in the transmission of the SRS1 are disposed at every other subcarrier position in the frequency direction. The subcarriers SC0 and the subcarriers SC1 included in the same frequency band 470 are disposed alternately in the frequency direction.

In this manner, the subcarriers which a communication terminal 2 uses for the transmission of the SRS are disposed in the form of comb teeth in the frequency direction. Thus, half of the subcarriers in a frequency band which the communication terminal 2 uses for the transmission of the SRS are used for the transmission of the SRS. A communication terminal 2 which transmits the SRS0 and a communication terminal 2 which transmits the SRS1 are allowed to use the same frequency band in the same uplink communication period for SRS, because the subcarriers SC0 and the subcarriers SC1 included in the same frequency band are disposed alternately. From the viewpoint of the base station 1, the base station 1 is able to make a distinction between the SRS0 and the SRS1 which are transmitted in the same frequency band in the same uplink communication period for SRS.

Although both the SRS0 and the SRS1 can be used in accordance with the LTE standard, only one of the SRS0 and the SRS1, e.g. only the SRS0, shall be used in the present embodiment. Thus, each of the communication terminals 2 according to the present embodiment transmits the SRS0 in at least one of the first uplink communication period for SRS 370a and the second uplink communication period for SRS 370b.

An uplink radio resource identified by the first uplink communication period for SRS 370a and the subcarriers SC0 in the form of comb teeth which are included in the SRS transmittable band 450 and usable for the transmission of the SRS0 is referred to as a “first uplink radio resource for SRS 500a hereinafter. Also, an uplink radio resource identified by the second uplink communication period for SRS 370b and the subcarriers SC0 in the form of comb teeth which are included in the SRS transmittable band 450 and usable for the transmission of the SRS0 is referred to as a “second uplink radio resource 500b for SRS”.

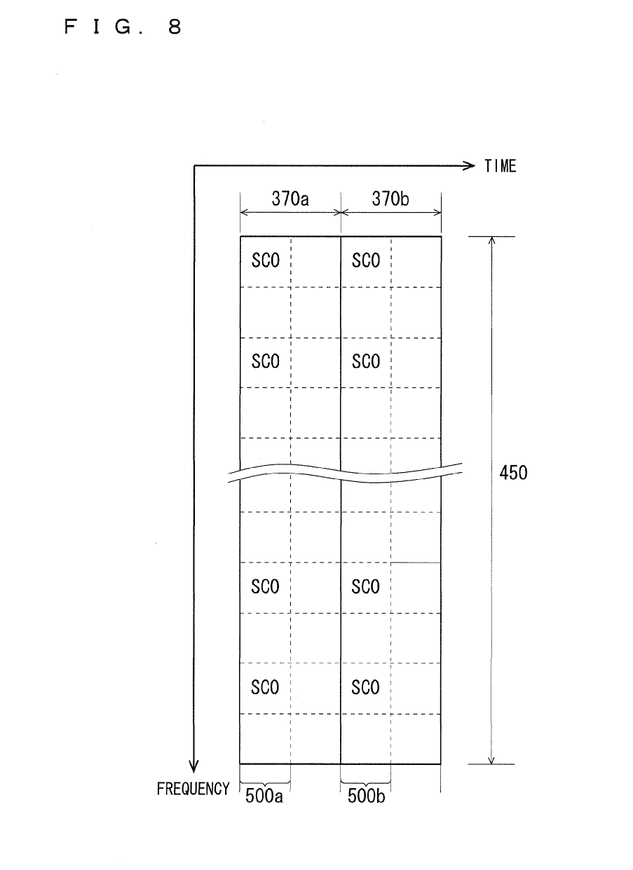

FIG. 8 shows the first uplink radio resource for SRS 500a and the second uplink radio resource for SRS 500b. As shown in FIG. 8, the first uplink radio resource for SRS 500a and the second uplink radio resource for SRS 500b coincide with each other in the frequency direction but differ from each other in the time direction. These uplink radio resources are referred to as “uplink radio resources for SRS” if the uplink radio resources need not particularly be identified.

Eight types of code patterns comprised of SRS symbols constituting the SRS are specified in LTE. Eight types of code sequences orthogonal to each other are adopted respectively for the eight types of code patterns. The communication terminals 2 transmit one of the eight types of code patterns as the SRS.

The SRSs transmitted from a maximum of eight communication terminals 2 can be multiplexed in accordance with the LTE standard, because the eight types of code patterns adopting the eight types of code sequences orthogonal to each other are specified for the SRSs. However, the multiplexing of the SRSs shall not be performed in the present embodiment.

<Frequency Hopping of SRS Band>

In the communication system 100 according to the present embodiment, a first allocatable uplink radio resource for SRS 600a allocatable as the use uplink radio resource for SRS to the communication terminals 2 is determined for the first uplink radio resource for SRS 500a. Also, a second allocatable uplink radio resource for SRS 600b allocatable as the use uplink radio resource for SRS to the communication terminals 2 is determined for the second uplink radio resource for SRS 500b. The frequency band of the first allocatable uplink radio resource for SRS 600a and the frequency band of the second allocatable uplink radio resource for SRS 600b differ from each other in each unit period 360.

The frequency bandwidth of each of the first allocatable uplink radio resource for SRS 600a and the second allocatable uplink radio resource for SRS 600b in the present embodiment is a bandwidth corresponding to 20 RBs, for example. Thus, the frequency bands of the first allocatable uplink radio resource for SRS 600a and the second allocatable uplink radio resource for SRS 600b in each unit period 360 are contiguous to each other and occupy the entire region of the SRS transmittable band 450.

Each base station 1 allocates the use uplink radio resource for SRS from at least one of the first allocatable uplink radio resource for SRS 600a and the second allocatable uplink radio resource for SRS 600b in a unit period 360 to the communication terminals 2. The first allocatable uplink radio resource for SRS 600a and the second allocatable uplink radio resource for SRS 600b are referred to hereinafter as “allocatable uplink radio resources for SRS” if the resources 600a and 600b need not be otherwise identified.

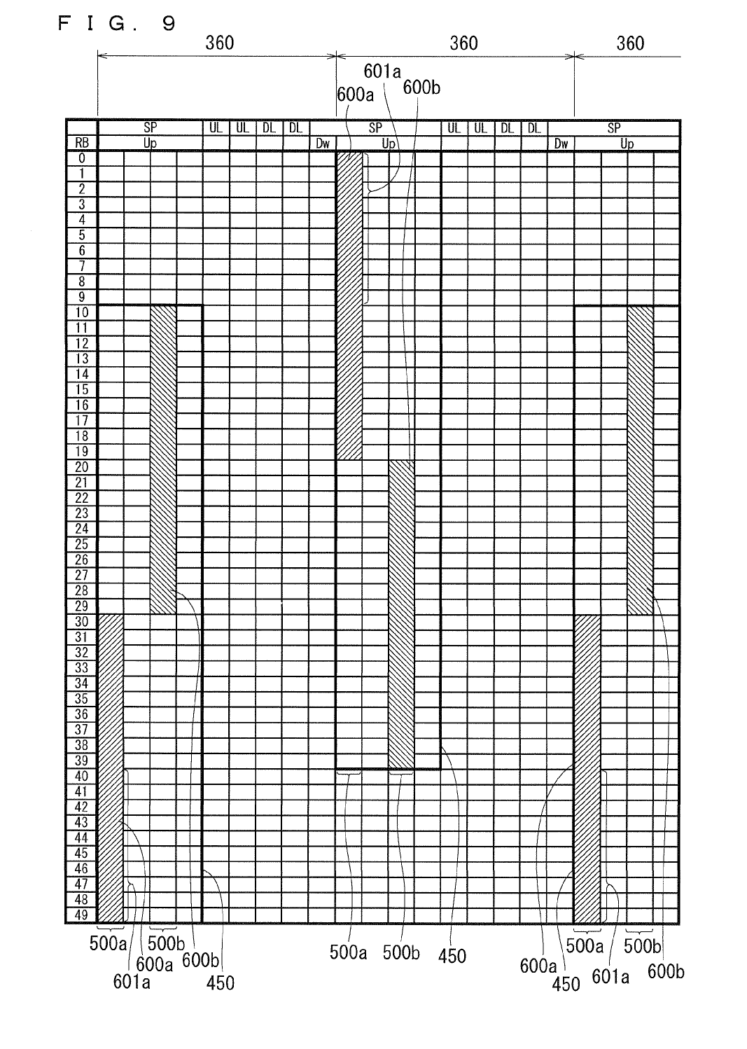

Further, the frequency bands of the allocatable uplink radio resources for SRS in the present communication system 100 are frequency-hopped in the SRS transmittable band 450 for each of the unit periods 360. FIG. 9 is a diagram showing such a state. Each of the sub-frames 302 in a plurality of consecutive unit periods 360 are shown in FIG. 9. In FIG. 9, the horizontal direction indicates the time direction, and the vertical direction indicates the frequency direction. The numbers in the range of 0 to 49 indicated in the leftmost portion of FIG. 9 indicate the numbers of 50 RBs arranged in the frequency direction. Also, “SP” indicated in FIG. 9 means the special sub-frame 302, “Up” means the uplink pilot time slot (UpPTS) 352, and “Dw” means the downlink pilot time slot (DwPTS) 351. Also, “UL” and “DL” indicated in FIG. 9 mean the uplink sub-frame 302 and the downlink sub-frame 302, respectively.

As shown in FIG. 9, the frequency bands of the allocatable uplink radio resources for SRS are disposed alternately on a high-frequency side and on a low-frequency side in the SRS transmittable band 450 for each of the unit periods 360.

Specifically, when the SRS transmittable band 450 in the special sub-frame 302 to which the frequency band of the first allocatable uplink radio resource for SRS 600a belongs is on the low-frequency side in the system band, the frequency band of the first allocatable uplink radio resource for SRS 600a is disposed on the low-frequency side in the SRS transmittable band 450. When the SRS transmittable band 450 is on the high-frequency side in the system band, the frequency band of the first allocatable uplink radio resource for SRS 600a is disposed on the high-frequency side in the SRS transmittable band 450. Thus, the frequency band of the first allocatable uplink radio resource for SRS 600a is disposed alternately on the high-frequency side and on the low-frequency side in the system band for each of the unit periods 360. Such frequency hopping of the first allocatable uplink radio resource for SRS 600a is referred to as “end hopping” hereinafter.

On the other hand, when the SRS transmittable band 450 in the special sub-frame 302 to which the frequency band of the second allocatable uplink radio resource for SRS 600b belongs is on the low-frequency side in the system band, the frequency band of the second allocatable uplink radio resource for SRS 600b is disposed on the high-frequency side in the SRS transmittable band 450. When the SRS transmittable band 450 is on the high-frequency side in the system band, the frequency band of the second allocatable uplink radio resource for SRS 600b is disposed on the low-frequency side in the SRS transmittable band 450. Thus, the frequency band of the second allocatable uplink radio resource for SRS 600b is disposed alternately on the high-frequency side and on the low-frequency side in a frequency band comprised of 30 RBs (the RBs numbered 10 through 39) lying in an intermediate portion of the system band for each of the unit periods 360. Such frequency hopping of the second allocatable uplink radio resource for SRS 600b is referred to as “intermediate hopping” hereinafter.

Because of the aforementioned frequency hopping of the frequency bands of the first allocatable uplink radio resource for SRS 600a and the second allocatable uplink radio resource for SRS 600b, the frequency band of the second allocatable uplink radio lease for SRS 600b in a leading one of two consecutive unit periods 360 is included in the frequency bands (40 consecutive RBs) of the first allocatable uplink radio resource for SRS 600a and the second allocatable uplink radio resource for SRS 600b in a trailing one thereof. The frequency band of the first allocatable uplink radio lease for SRS 600a in the leading unit period 360 includes a partial frequency band 601a which is not included in the frequency bands of the first allocatable uplink radio resource for SRS 600a and the second allocatable uplink radio resource for SRS 600b in the trailing unit period 360. In the example of FIG. 9, the partial frequency band 601a included in the frequency band of the first allocatable uplink radio resource for SRS 600a in the first and last unit periods 360 is a frequency band corresponding to the RBs numbered 34 through 49, and the partial frequency band 601a included in the frequency band of the first allocatable uplink radio resource for SRS 600a in the middle unit period 360 is a frequency band corresponding to the RBs numbered 0 through 9.

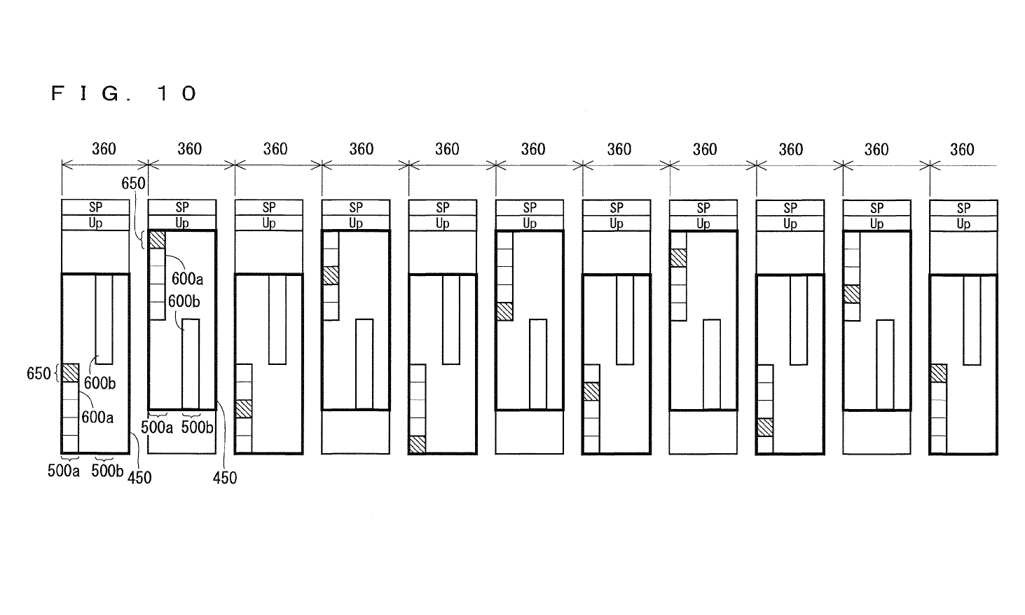

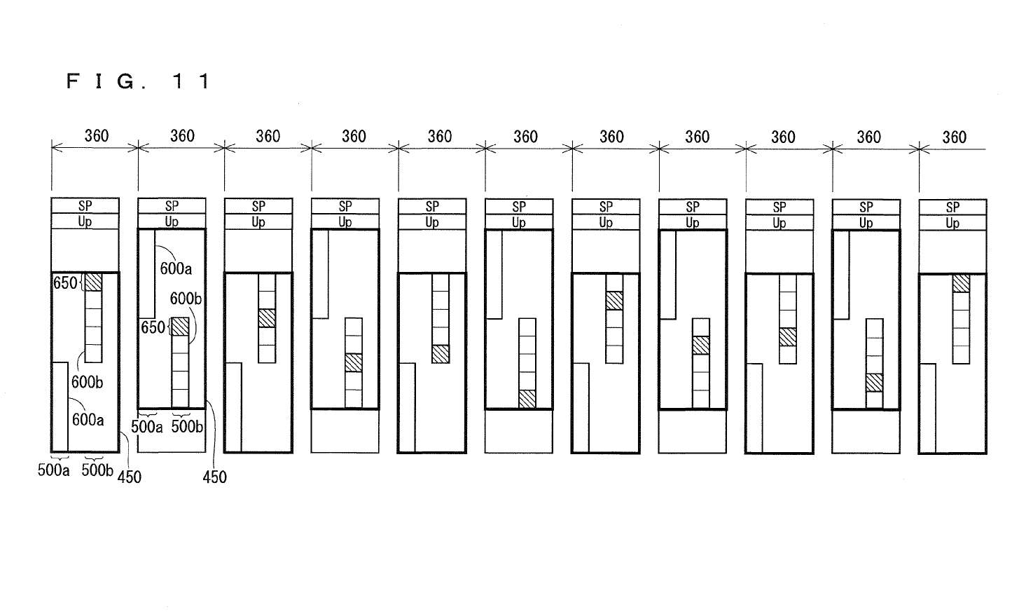

In the communication system 100 according to the present embodiment, a frequency band (referred to hereinafter as an “SRS band”) which a single communication terminal 2 uses for the single transmission of the SRS is frequency-hopped in the frequency band of an allocatable uplink radio resource for SRS for each of the unit periods 360. FIGS. 10 and 11 show the frequency hopping of the SRS band for a certain communication terminal 2. A communication terminal 2 about which description is given is referred to as a “target communication terminal 2” hereinafter.

A plurality of bandwidths different in magnitude from each other are determined as a bandwidth that can be set as the transmission frequency bandwidth of the SRS in the present communication system 100. Examples of such determined bandwidths include three bandwidths: a bandwidth corresponding to 40 RBs, a bandwidth corresponding to 20 RBs, and a bandwidth corresponding to 4 RBs. In each base station 1 according to the present embodiment, the smallest of the three bandwidths, i.e. the bandwidth corresponding to 4 RBs, is set as the transmission frequency bandwidth of the SRS for each communication terminal 2. In other words, the frequency bandwidth of the use uplink radio resource for SRS to be allocated to each communication terminal 2 is set to the bandwidth corresponding to 4 RBs. The bandwidth corresponding to RBs the number of which is x is referred to simply as “x RBs” hereinafter.

Only portions of the special sub-frames 302 in consecutive TDD frames 300 which include the uplink pilot time slots 351 in the time direction are shown in FIGS. 10 and 11. An SRS band 650 for a target communication terminal 2 is diagonally shaded in FIGS. 10 and 11. In the example of FIG. 10, the use uplink radio resource for SRS having a frequency bandwidth of 4 RBs is allocated from the first allocatable uplink radio resource for SRS 600a to the target communication terminal 2. In the example of FIG. 11, the use uplink radio resource for SRS having a frequency bandwidth of 4 RBs is allocated from the second allocatable uplink radio resource for SRS 600b to the target communication terminal 2.

As shown in FIGS. 10 and 11, the SRS band 650 is frequency-hopped at intervals of two unit periods 360 (at intervals of 10 ms) within the frequency band of an allocatable uplink radio resource for SRS. Then, the SRS band 650 returns to the original frequency band at intervals of ten unit periods 360 (at intervals of 50 ms).

More specifically, each time the frequency band of the first allocatable uplink radio resource for SRS 600a is disposed on the low-frequency side in the SRS transmittable band 450, the SRS band 650 for the target communication terminal 2 to which the use radio resource for SRS is allocated from the first allocatable uplink radio resource for SRS 600a is frequency-hopped within the frequency band of the first allocatable uplink radio resource for SRS 600a, as shown in FIG. 10. Also, each time the frequency band of the second allocatable uplink radio resource for SRS 600b is disposed on the high-frequency side in the SRS transmittable band 450, the SRS band 650 for the target communication terminal 2 to which the use radio resource for SRS is allocated from the second allocatable uplink radio resource for SRS 600b is frequency-hopped within the frequency band of the second allocatable uplink radio resources for SRS 600b, as shown in FIG. 11.

Dividing the frequency band of an allocatable uplink radio resource for SRS in units of 4 RBs provides five partial frequency bands. The five partial frequency bands are numbered 1 through 5. Then, the SRS band 650 changes so as to coincide with the partial frequency bands in the order of the partial frequency bands numbered 1, 3, 5, 2 and 4, and repeats such a change. It should be noted that, when the target communication terminal 2 starts the transmission of the SRS, the SRS band 650 does not always start at the partial frequency band numbered 1, but might start at the partial frequency band numbered 5, for example.

The radio resource allocating section 122 according to the present embodiment determines whether to cause each communication terminal 2 with which the base station 1 communicates to perform the 5-ms cycle transmission or the shortest cycle transmission. When the radio resource allocating section 122 determines to cause the target communication terminal 2 to perform the 5-ms cycle transmission, the radio resource allocating section 122 determines the allocatable uplink radio resource for SRS which the target communication terminal 2 uses for the transmission of the SRS from the first allocatable uplink radio resource for SRS 600a and the second allocatable uplink radio resources for SRS 600b. On the other hand, when the radio resource allocating section 122 determines to cause the target communication terminal 2 to perform the smallest cycle transmission, the radio resource allocating section 122 determines that the allocatable uplink radio resources for SRS which the target communication terminal 2 uses for the transmission of the SRS are both the first allocatable uplink radio resource for SRS 600a and the second allocatable uplink radio resource for SRS 600b.

Thereafter, the radio resource allocating section 122 determines the transmission frequency bandwidth of the SRS, the mode of frequency hopping of the SRS band 650, the value of the parameter k_{TC} and the like. Thus, when each of the communication terminals 2 with which the base station 1 communicates is caused to perform the 5-ms cycle transmission, the use uplink radio resource for SRS is allocated from one of the allocatable uplink radio resources for SRS to be used to each communication terminal 2. On the other hand, when each communication terminal 2 is caused to perform the shortest cycle transmission, the use uplink radio resource for SRS is allocated from both the first allocatable SRS uplink radio resource 600a and the second allocatable uplink radio resource for SRS 600b to each communication terminal 2.

In the present embodiment, as mentioned above, the transmission frequency bandwidth of the SRS is set to 4 RBs and the value of the parameter k_{TC} is set to “0” for each communication terminal 2. The mode of the frequency hopping of the SRS band 650 is determined so that the SRS band 650 is frequency-hopped as shown in FIGS. 10 and 11.

In this manner, the radio resource allocating section 122 determines the transmission mode of the SRS for the target communication terminal 2 to thereby allocate the use uplink radio resource for SRS to the target communication terminal 2.

The transmission signal generating section 120 generates a transmission signal including control data for notifying the target communication terminal 2 about the use uplink radio resource for SRS allocated to the target communication terminal 2 by the radio resource allocating section 122, that is, control data (referred to hereinafter as “SRS control data”) for notifying the target communication terminal 2 about the transmission mode of the SRS to be transmitted from the target communication terminal 2 which is determined by the radio resource allocating section 122. This transmission signal is transmitted from the communication section 13 to the target communication terminal 2 by using the downlink sub-frame 302. Thus, the SRS control data is transmitted to each communication terminal 2. This allows each communication terminal 2 to know the uplink radio resource for use in transmitting the SRS. In other words, this allows each communication terminal 2 to know the transmission mode of the SRS to be transmitted therefrom. Each communication terminal 2 transmits the SRS by using the use uplink radio resource for SRS about which notification is provided from the base station 1.

It should be noted that the SRS control data includes transmission start data for providing an instruction to start the transmission of the SRS or transmission stop data for providing an instruction to stop the transmission of the SRS. Upon receipt of the SRS control data including the transmission start data, a communication terminal 2 which is not transmitting the SRS starts the transmission of the SRS by using the use uplink radio resource for SRS about which notification is received using the SRS control data. Upon receipt of the SRS control data including the transmission stop data, a communication terminal 2 which is transmitting the SRS stops the transmission of the SRS. To change the uplink radio resource which a communication terminal 2 uses for the transmission of the SRS, notification about the SRS control data for providing notification about a new use uplink radio resource for SRS is provided to the communication terminal 2. The SRS control data is referred to as an “RRCConnectionReconfiguration message” in LTE.

<Series of Operations in Communication System in Controlling Transmission of SRS>

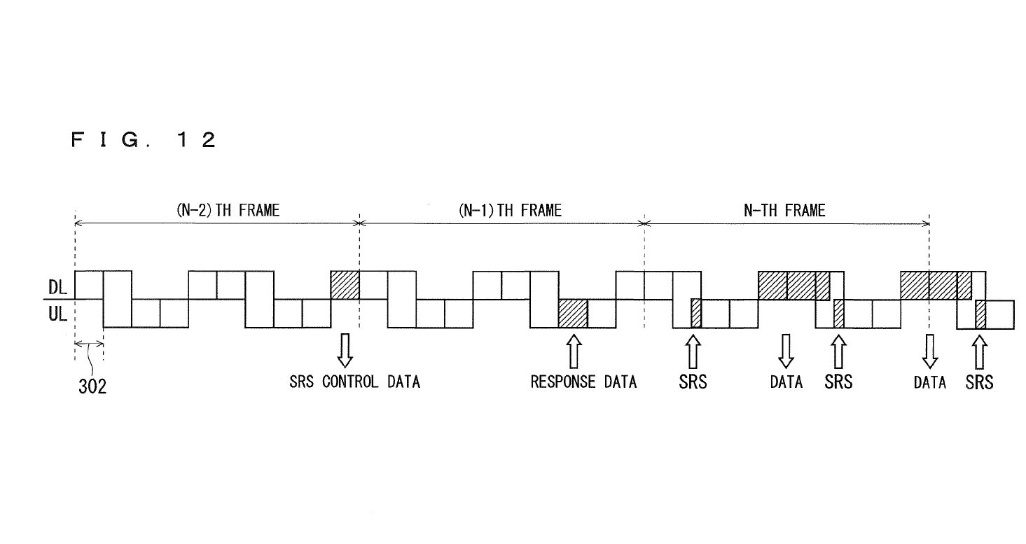

Next, description will be given on a series of operations in the communication system 100 after the target communication terminal 2 receives the SRS control data and until the target communication terminal 2 transmits the SRS by using the use uplink radio resource for SRS about which notification is received using the SRS control data. FIG. 12 is a diagram showing such a series of operations.

As shown in FIG. 12, after a transmission signal including the SRS control data is transmitted from the base station 1 to the target communication terminal 2, for example, in the downlink sub-frame 302 positioned in the trailing end of the (N−2)th TDD frame 300, the target communication terminal 2 transmits a transmission signal including response data for notifying the base station 1 that the SRS control data is normally received to the base station 1 in the eighth uplink sub-frame 302 (the seventh sub-frame 302) from the leading end of the subsequent (N−1)th TDD frame 300. Such response data is referred to as an “RRCConnectionReconfigurationComplete message.”

After transmitting the response data, the target communication terminal 2 transmits the SRS in and after the next or N-th TDD frame 300 by using the use uplink radio resource for SRS about which the instruction is provided by the received SRS control data, that is, based on the transmission mode about which notification is received using the SRS control data.

In the example of FIG. 12, the target communication terminal 2 transmits the response data in the (N−1)th TDD frame 300. However, the target communication terminal 2 transmits the response data in a TDD frame 300 subsequent to the (N−1)th TDD frame 300 in some cases.

In the case where a communication terminal 2 which is transmitting the SRS receives the SRS control data for providing notification about a new use uplink radio resource for SRS allocated to the communication terminal 2, the target communication terminal 2 transmits the SRS by using the current use uplink radio resource for SRS until transmitting the SRS by using the new use uplink radio resource for SRS about which notification is provided using the by the SRS control data (in the example of FIG. 12, until the second special sub-frame 302 of the (N−1)th TDD frame 300).

In this manner, after the base station 1 transmits the SRS control data to the target communication terminal 2 in a certain TDD frame 300, the target communication terminal 2 transmits the SRS, based on the SRS control data, in and after a TDD frame 300 which is at least the next but one counting from the certain TDD frame 300. Thus, in the case where the base station 1 instructs the target communication terminal 2 to start the transmission of the SRS or to change the transmission mode of the SRS, it takes a certain amount of time between the transmission of the SRS control data to the target communication terminal 2 and the reception of the SRS transmitted from the target communication terminal 2, based on the SRS control data.

The communication system 100 operates similarly in the case where the base station 1 instructs a communication terminal 2 which is transmitting the SRS to stop the transmission of the SRS. For example, after the SRS control data including the transmission stop data is transmitted from the base station 1 to the target communication terminal 2 in the downlink sub-frame 302 positioned in the trailing end of the (N−2)th TDD frame 300, the target communication terminal 2 transmits the response data for notifying the base station 1 that the SRS control data is normally received to the base station 1 in the eighth uplink sub-frame 302 (the seventh sub-frame 302) from the leading end of the subsequent (N−1)th TDD frame 300. After transmitting the response data, the target communication terminal 2 stops transmitting the SRS in the next or N-th TDD frame 300.

Thus, in the case where the base station 1 instructs the target communication terminal 2 to stop the transmission of the SRS, it takes a certain amount of time between the transmission of the SRS control data to the target communication terminal 2 and the stop of the transmission of the SRS from the target communication terminal 2.

<Method of Allocating Use Downlink Radio Resources to Communication Terminals>

Next, a method of allocating the use downlink radio resources to the communication terminals 2 in the radio resource allocating section 122 will be described in detail.

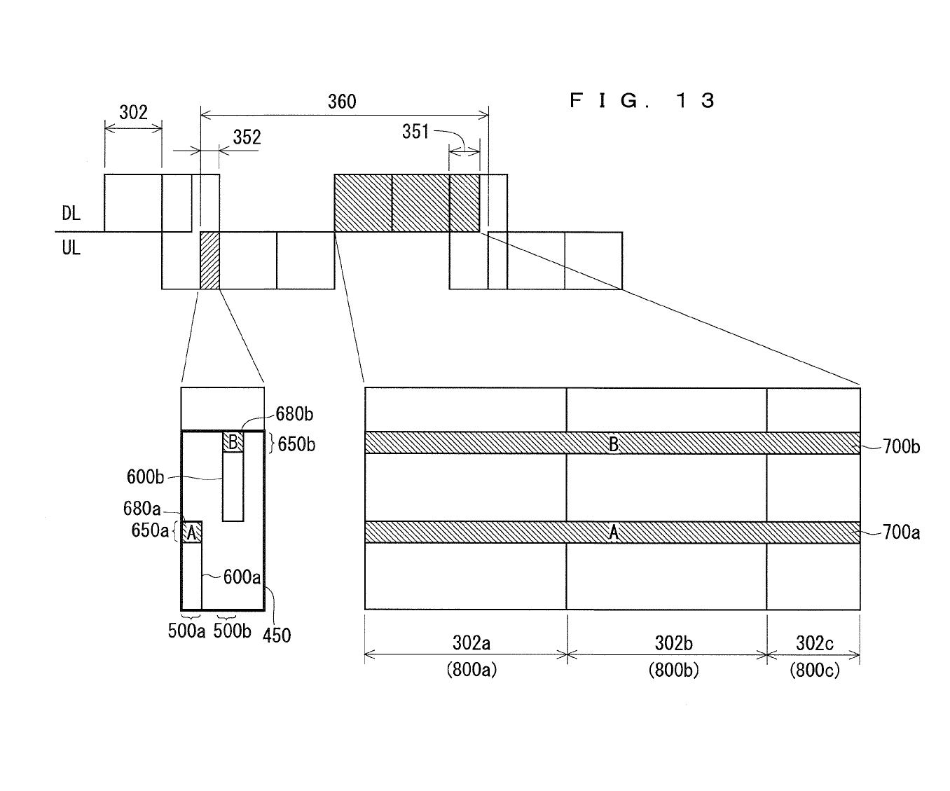

FIG. 13 is a diagram for illustrating the method of allocating the use downlink radio resources to the communication terminals 2 according to the present embodiment. A use downlink radio resource 700a allocated to a communication terminal 2 having a terminal number A which transmits the SRS in a certain unit period 360 and a use downlink radio resource 700b allocated to a communication terminal 2 having a terminal number B which transmits the SRS in the certain unit period 360 are shown in FIG. 13. In the example of FIG. 13, the communication terminal 2 having the terminal number A uses a use uplink radio resource for SRS 680a included in the first allocatable uplink radio resource for SRS 600a to transmit the SRS, and the communication terminal 2 having the terminal number B uses a use uplink radio resource for SRS 680b included in the second allocatable uplink radio resource for SRS 600b to transmit the SRS. A unit period 360 about which description is given is referred to hereinafter as a “target unit period 360” in some cases.

Part of the special sub-frame 302 which includes the downlink pilot time slot 351 in the time direction is not the downlink sub-frame 302. However, the downlink sub-frame 302 shall include this part for convenience of description. Two downlink sub-frames 302 included in the unit period 360 are referred to as first and second downlink sub-frame 302a and 302b, respectively. Part of the special sub-frame 302 included in the unit period 360 which includes the downlink pilot time slot 351 in the time direction is referred to as a third downlink sub-frame 302c. Also, 14 symbol periods 304 included in the first downlink sub-frame 302a in the time direction are referred to as a “first downlink communication period 800a”, and 14 symbol periods 304 included in the second downlink sub-frame 302b in the time direction are referred to as a “second downlink communication period 800b”. Eleven symbol periods 304 included in the third downlink sub-frame 302c in the time direction are referred to as a “third downlink communication period 800c”.

In the present embodiment, a downlink radio resource including the first downlink communication period 800a, the second downlink communication period 800b and the third downlink communication period 800c included in a unit period 360 as seen in the time direction is allocated as the use downlink radio resource to each communication terminal 2 which transmits the SRS in the unit period 360. Also, in present embodiment, a downlink radio resource including a frequency band included in the transmission frequency band (the SRS band 650) of the SRS as seen in the frequency direction is allocated as the use downlink radio resource to each communication terminal 2 which transmits the SRS in the unit period 360. In other words, a downlink radio resource which includes the frequency band included in the transmission frequency band of the SRS in the frequency direction and which includes the first downlink communication period 800a, the second downlink communication period 800b and the third downlink communication period 800c included in a unit period 360 in the time direction is allocated as the use downlink radio resource to each communication terminal 2 which transmits the SRS in the unit period 360.

In the example of FIG. 13, a downlink radio resource which includes a frequency band included in an SRS band 650a for the communication terminal 2 having the terminal number A in the frequency direction and which includes the first downlink communication period 800a, the second downlink communication period 800b and the third downlink communication period 800c in the time direction is allocated as the use downlink radio resource 700a to the communication terminal 2 having the terminal number A. Also, a downlink radio resource which includes a frequency band included in an SRS band 650b for the communication terminal 2 having the terminal number B in the frequency direction and which includes the first downlink communication period 800a, the second downlink communication period 800b and the third downlink communication period 800c in the time direction is allocated as the use downlink radio resource 700b to the communication terminal 2 having the terminal number B.

In the present embodiment, a frequency band corresponding to 3 RBs is defined as a single allocation unit in the frequency direction, and the use downlink radio resource is allocated to a communication terminal 2 for each allocation unit. Of the communication terminals 2 which transmit the SRS in a unit period 360, there is a communication terminal 2 to which a downlink radio resource including a single RB adjacent to the transmission frequency band of the SRS in the frequency direction and including the first downlink communication period 800a, the second downlink communication period 800b and the third downlink communication period 800c included in the unit period 360 in the time direction is allocated as the use downlink radio resource. This will be described in detail.

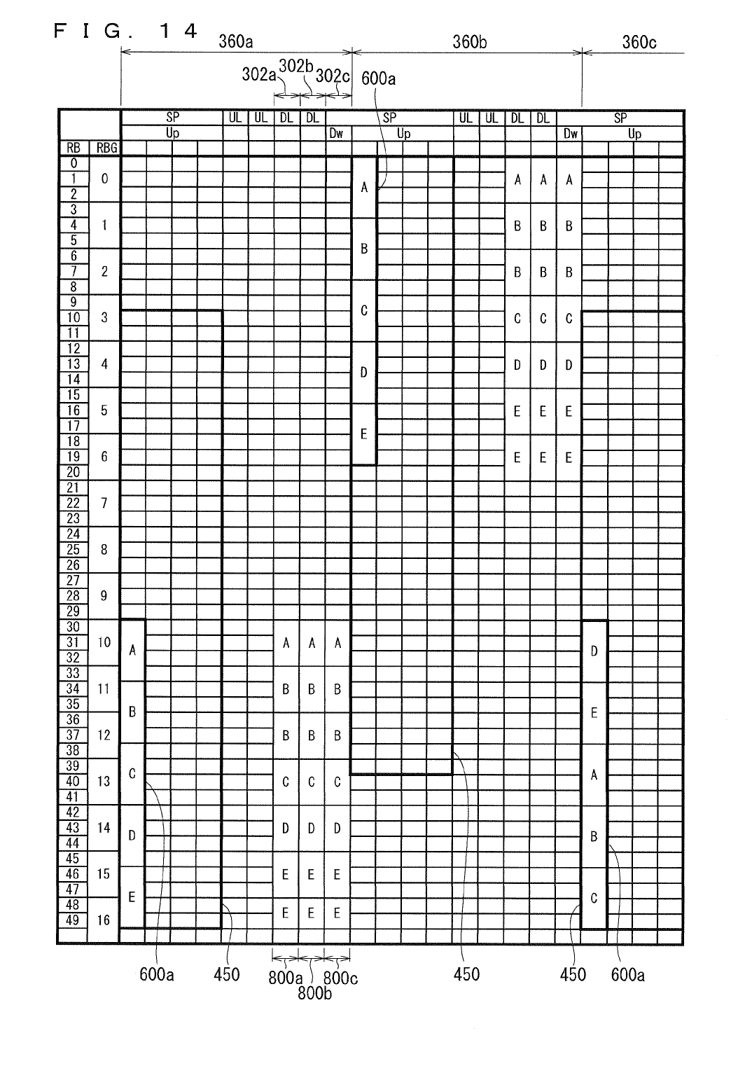

FIG. 14 is a diagram showing an example of the allocation of the use downlink radio resources to the communication terminals 2 in a plurality of unit periods 360. An example of the allocation of the use downlink radio resources to the communication terminals 2 having terminal numbers A to E which transmit the SRS by using part of the first allocatable uplink radio resource for SRS 600a is shown in FIG. 14. The three unit periods 360 shown in FIG. 14 are referred to hereinafter as a unit period 360a, a unit period 360b and a unit period 360c in order from the leading end.

In the present embodiment, a system band comprised of 50 RBs is divided into 17 partial frequency bands. Each of the 16 partial frequency bands on the low-frequency side which are included in the system band has a bandwidth of 3 RBs, and the remaining one partial frequency band included in the system band has a bandwidth of 2 RBs. Numbers 0 to 16 are assigned to the 17 partial frequency bands constituting the system band in order of increasing frequency. Each of the partial frequency bands is referred to hereinafter as an RBG (resource block group). In the present embodiment, the use downlink radio resource is allocated to a communication terminal 2 for each RGB.

In the first unit period 360a in the example of FIG. 14, the use downlink radio resource including the RBG numbered 10 in the frequency direction is allocated to the communication terminal 2 having the terminal number A which transmits the SRS having a transmission frequency band including the RGB numbered 10, for example.

In the unit period 360a, the use downlink radio resources including the RBG numbered 11 and the resource block numbered 12 in the frequency direction are allocated to the communication terminal 2 having the terminal number B which transmits the SRS having a transmission frequency band including part of the RBG numbered 11 corresponding to 2 RBs and part of the RBG numbered 12 corresponding to 2 RBs. To the communication terminal 2 having the terminal number B are allocated the use downlink radio resource including the transmission frequency band of the SRS transmitted from this communication terminal 2 in the frequency direction, the use downlink radio resource including one RB adjacent to the transmission frequency band on the low-frequency side in the frequency direction, and the use downlink radio resource including one RB adjacent to the transmission frequency band on the high-frequency side in the frequency direction.

In the unit period 360a, the use downlink radio resources including the RBG numbered 15 and the RBG numbered 16 in the frequency direction are allocated to the communication terminal 2 having the terminal number E which transmits the SRS having a transmission frequency band including part of the RBG numbered 15 corresponding to 2 RBs and the RBG numbered 16. To the communication terminal 2 having the terminal number E are allocated the use downlink radio resource including the transmission frequency band of the SRS transmitted from this communication terminal 2 in the frequency direction, and the use downlink radio resource including one RB adjacent to the transmission frequency band on the low-frequency side in the frequency direction.

In the second unit period 360b from the leading end, the use downlink radio resources including the RBG numbered 1 and the RBG numbered 2 in the frequency direction are allocated to the communication terminal 2 having the terminal number B which transmits the SRS having a transmission frequency band including part of the RBG numbered 1 corresponding to 2 RBs and part of the RBG numbered 2 corresponding to 2 RBs. To the communication terminal 2 having the terminal number B are allocated the use downlink radio resource including the transmission frequency band of the SRS transmitted from this communication terminal 2 in the frequency direction, the use downlink radio resource including one RB adjacent to the transmission frequency band on the low-frequency side in the frequency direction, and the use downlink radio resource including one RB adjacent to the transmission frequency band on the high-frequency side in the frequency direction.

In the unit period 360b, the use downlink radio resource including the RBG numbered 3 in the frequency direction is allocated to the communication terminal 2 having the terminal number C which transmits the SRS having a transmission frequency band including the RBG numbered 3.

In the unit period 360b, the use downlink radio resources including the RBG numbered 5 and the RBG numbered 6 in the frequency direction are allocated to the communication terminal 2 having the terminal number E which transmits the SRS having a transmission frequency band including part of the RBG numbered 5 corresponding to 2 RBs and part of the RBG numbered 6 corresponding to 2 RBs. To the communication terminal 2 having the terminal number E are allocated the use downlink radio resource including the transmission frequency band of the SRS transmitted from this communication terminal 2 in the frequency direction, the use downlink radio resource including one RB adjacent to the transmission frequency band on the low-frequency side in the frequency direction, and the use downlink radio resource including one RB adjacent to the transmission frequency band on the high-frequency side in the frequency direction.

In the present embodiment, because the use downlink radio resource is allocated for each RBG having a bandwidth of 3 RBs, not only the use downlink radio resource including a frequency band included in the transmission frequency band of the SRS transmitted from some communication terminals 2 in the frequency direction but also the use downlink radio resource including at least one of the one RB adjacent to the transmission frequency band on the low-frequency side and the one RB adjacent to the transmission frequency band on the high-frequency side in the frequency direction are allocated to some communication terminals 2 in this manner. That is, when the use downlink radio resource including one RBG in the frequency direction is allocated from the downlink radio resources in a unit period 360 to a communication terminal 2 which transmits the SRS in the unit period 360 in association with the transmission frequency band of the SRS in the present embodiment, the use downlink radio resource is set so as to include only the transmission frequency band of the SRS in the frequency direction or to include the transmission frequency band of the SRS and one RB adjacent to the transmission frequency band.

An example of the allocation of the use downlink radio resources to the communication terminals 2 which transmit the SRS by using part of the first allocatable downlink radio resource for SRS 600a is shown in FIG. 14. The same holds true for the allocation of the use downlink radio resources to the communication terminals 2 which transmit the SRS by using part of the second allocatable downlink radio resource for SRS 600b.

In the present embodiment, the use downlink radio resources are allocated not only from the downlink radio resources in a leading one of two consecutive unit periods 360 but also from the downlink radio resources in a trailing one thereof to the communication terminal 2 which transmits the SRS in the frequency band of the first allocatable uplink radio resource for SRS 600a in the leading unit period 360 by using a frequency band included in the partial frequency band 601a which is not included in the frequency bands (the SRS transmittable band 450) of the first allocatable uplink radio resource for SRS 600a and the second allocatable uplink radio resource for SRS 600b in the trailing unit period 360.

The communication terminal 2 which transmits the SRS in the frequency band of the first allocatable uplink radio resource for SRS 600a in a leading one of two consecutive unit periods 360 by using the frequency band included in the partial frequency band 601a which is not included in the SRS transmittable band 450 in a trailing one thereof is referred to hereinafter as a “consecutive-allocation terminal 2” in the leading unit period 360. The use downlink radio resource allocated from the downlink radio resources in a certain unit period 360 to the consecutive-allocation terminal 2 in the certain unit period 360 (with reference to FIG. 14) is referred to as a “fundamental use downlink radio resource”, and the use downlink radio resource allocated from the downlink radio resources in the unit period next to the certain unit period 360 is referred to as an “additional use downlink radio resource”.

The allocation of the additional use downlink radio resource to the consecutive-allocation terminal 2 is similar to that of the fundamental use downlink radio resource thereto. To the consecutive-allocation terminal 2 in a certain unit period 360 is allocated either the downlink radio resource including the transmission frequency band of the SRS transmitted from the consecutive-allocation terminal 2 in the certain unit period 360 in the frequency direction and including the first downlink communication period 800a, the second downlink communication period 800b and the third downlink communication period 800c included in the unit period 360 next to the certain unit period 360 in the time direction as the additional use downlink radio resource or the downlink radio resource including the transmission frequency band of the SRS and at least one of the one RB adjacent to the transmission frequency band on the low-frequency side and the one RB adjacent to the transmission frequency band on the high-frequency side in the frequency direction and including the first downlink communication period 800a, the second downlink communication period 800b and the third downlink communication period 800c included in the next unit period 360 in the time direction as the additional use downlink radio resource. When the additional use downlink radio resource including one RBG in the frequency direction is allocated from the downlink radio resources in the unit period 360 next to a certain unit period 360 to the consecutive-allocation terminal 2 in the certain unit period 360 in association with the transmission frequency band of the SRS transmitted from the consecutive-allocation terminal 2 in the certain unit period 360, the additional use downlink radio resource is set so as include only the transmission frequency band of the SRS in the frequency direction or to include the transmission frequency band of the SRS and one RB adjacent to the frequency band of the SRS.

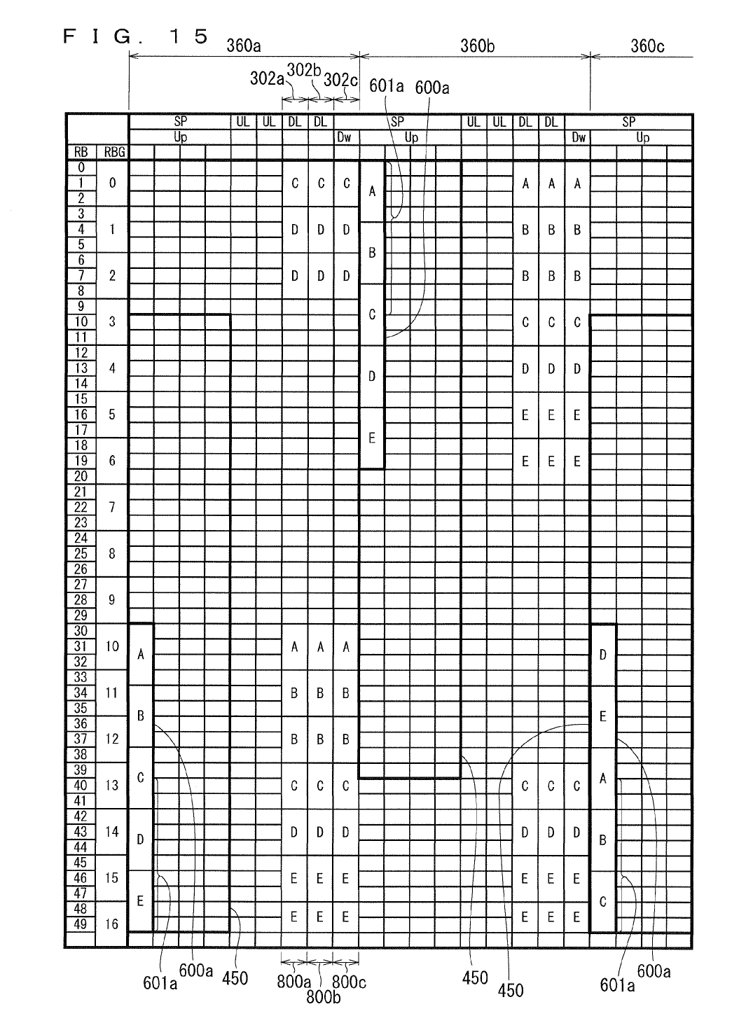

FIG. 15 is a diagram obtained by adding the additional use downlink radio resources to FIG. 14 described above. In the example of FIG. 15, not only the fundamental use downlink radio resource is allocated from the downlink radio resources in the unit period 360a to the communication terminal 2 having the terminal number C which transmits the SRS in the frequency band of the first allocatable uplink radio resource for SRS 600a in the first unit period 360a by using the frequency band included in the partial frequency band 601a which is not included in the SRS transmittable band 450 in the unit period 360b next to the unit period 360a, but also the additional use downlink radio resource is allocated from the downlink radio resources in the next unit period 360b to this communication terminal 2 having the terminal number C. In the example of FIG. 15, this additional use downlink radio resource includes the RBG numbered 13 in the frequency direction and includes the first downlink communication period 800a, the second downlink communication period 800b and the third downlink communication period 800c included in the unit period 360b in the time direction.

Similarly, the fundamental use downlink radio resources are allocated from the downlink radio resources in the unit period 360a to the communication terminals 2 having the terminal numbers D and E which transmit the SRS by using the frequency band included in the partial frequency band 601a in the frequency band of the first allocatable uplink radio resource for SRS 600a in the unit period 360a, and the additional use downlink radio resources are allocated from the downlink radio resources in the next unit period 360b to these communication terminals 2 having the terminal numbers D and E.

In the unit period 360 immediately preceding the unit period 360a, the communication terminal 2 having the terminal number C transmits the SRS by using the RBs numbered 0 through 3, and the communication terminal 2 having the terminal number D transmits the SRS by using the RBs numbered 4 through 7, although not shown in FIG. 15. The downlink radio resource including the first to third downlink communication periods 800a to 800c included in the unit period 360a in the time direction and including the RBs numbered 0 through 2 (the RBG numbered 0) in the frequency direction is allocated to the communication terminal 2 having the terminal number C which transmits the SRS by using the RBs numbered 0 through 3 (the consecutive-allocation terminal 2 in the preceding unit period 360) as the additional use downlink radio resource in the unit period 360 immediately preceding the unit period 360a. The downlink radio resources including the first to third downlink communication periods 800a to 800c included in the unit period 360a in the time direction and including the RBs numbered 3 through 8 (the RBGs numbered 1 and 2) in the frequency direction is allocated to the communication terminal 2 having the terminal number D which transmits the SRS by using the RBs numbered 4 through 7 (the consecutive-allocation terminal 2 in the preceding unit period 360) as the additional use downlink radio resource in the unit period 360 immediately preceding the unit period 360a.

<About Array Transmission Control>

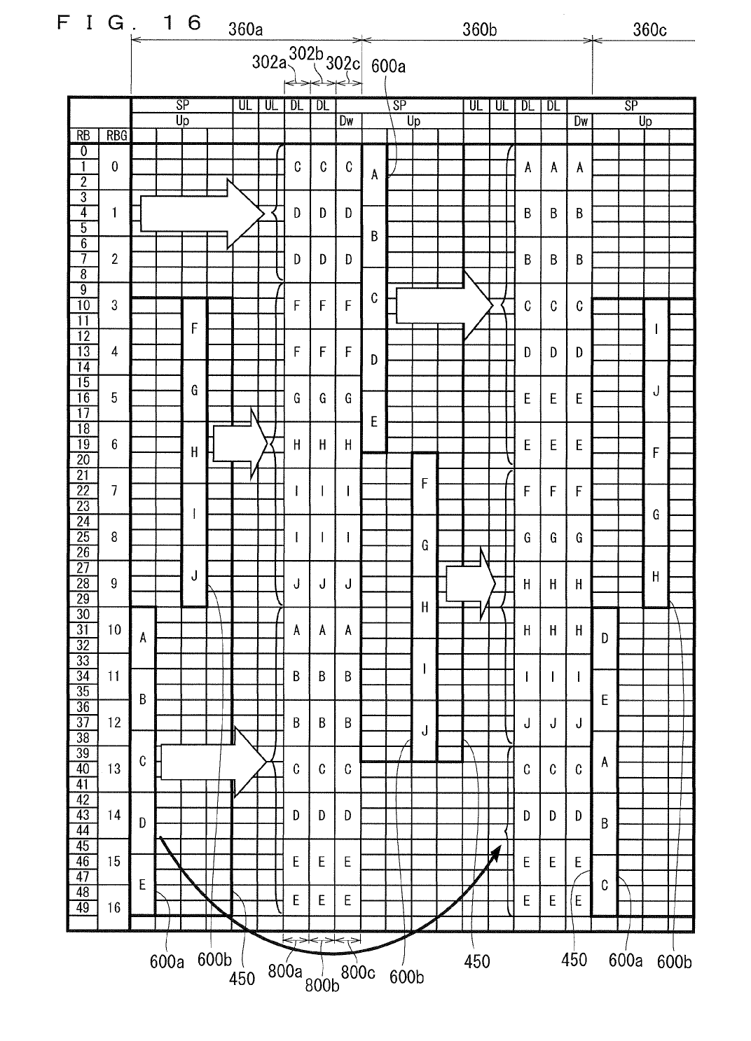

For the downlink communication with a communication terminal 2 by using a use downlink radio resource including one RBG in the frequency direction in a unit period 360 in the present embodiment, the array transmission control is performed based on an SRS having a transmission frequency band including a frequency band included in the RBG in the case where the communication terminal 2 transmits the SRS in the unit period 360. For the downlink communication with a communication terminal 2 by using a use downlink radio resource including one RBG in the frequency direction in a certain unit period 360, the array transmission control is performed, on the other hand, based on an SRS having a transmission frequency band including a frequency band included in the RBG which the communication terminal 2 transmits in a unit period 360 immediately preceding the certain unit period 360 in the case where the communication terminal 2 is not transmitting the SRS in the unit period 360. The array transmission control according to the present embodiment will be described in detail with reference to FIG. 16.

FIG. 16 is a diagram showing an example of the allocation of the use downlink radio resources to ten communication terminals 2 having terminal numbers A to J in the case where the base station 1 performs downlink communication with the ten communication terminals 2. An example of the allocation of the use downlink radio resources to the communication terminals 2 having the terminal numbers A to E in FIG. 16 is similar to that in FIG. 15 described above. The communication terminals 2 having the terminal numbers A to E transmit the SRS by using part of the first allocatable uplink radio resource for SRS 600a, and the communication terminals 2 having the terminal numbers F to J transmit the SRS by using part of the second allocatable uplink radio resource for SRS 600b.

For the downlink communication with the communication terminal 2 having the terminal number A by using the use downlink radio resource including the RBG numbered 10 in the frequency direction in the first unit period 360a in the example of FIG. 16, the array transmission control is performed based on an SRS having a transmission frequency band including a frequency band included in the RBG numbered 10 (the RBs numbered 30 through 32) because the communication terminal 2 transmits the SRS in the unit period 360a.

For the downlink communication with the communication terminal 2 having the terminal number F by using the use downlink radio resource including the RBG numbered 3 in the frequency direction in the first unit period 360a, the array transmission control is performed based on an SRS having a transmission frequency band including a frequency band included in the RBG numbered 3 (the RBs numbered 10 and 11) because the communication terminal 2 transmits the SRS in the unit period 360a.

For the downlink communication with the communication terminal 2 having the terminal number F by using the use downlink radio resource including the RBG numbered 4 in the frequency direction in the first unit period 360a, the array transmission control is performed based on an SRS having a transmission frequency band including a frequency band included in the RBG numbered 4 (the RBs numbered 12 and 13) because the communication terminal 2 transmits the SRS in the unit period 360a.

For the downlink communication with the communication terminal 2 having the terminal number D by using the use downlink radio resource including the RBG numbered 4 in the frequency direction in the second unit period 360b, the array transmission control is performed based on an SRS having a transmission frequency band including a frequency band included in the RBG numbered 4 (the RBs numbered 12 through 14) because the communication terminal 2 transmits the SRS in the unit period 360b.

For the downlink communication with the communication terminal 2 having the terminal number I by using the use downlink radio resource including the RBG numbered 11 in the frequency direction in the unit period 360b, the array transmission control is performed based on an SRS having a transmission frequency band including a frequency band included in the RBG numbered 11 (the RBs numbered 33 through 35) because the communication terminal 2 transmits the SRS in the unit period 360b.

For the downlink communication with the communication terminal 2 having the terminal number C by using the use downlink radio resource including the RBG numbered 13 in the frequency direction in the second unit period 360b, on the other hand, the communication terminal 2 having the terminal number C is not transmitting an SRS having a transmission frequency band including a frequency band included in the RBG numbered 13 in the unit period 360b. In this case, the array transmission control is performed based on the SRS having the transmission frequency band including the frequency band included in the RBG numbered 13 (the RBs numbered 39 through 41) which the communication terminal 2 having the terminal number C transmits in the unit period 360a immediately preceding the unit period 360b.

For the downlink communication with the communication terminal 2 having the terminal number E by using the use downlink radio resource including the RBG numbered 15 in the frequency direction in the unit period 360b, the communication terminal 2 having the terminal number E is not transmitting an SRS having a transmission frequency band including a frequency band included in the RBG numbered 15 in the unit period 360b. In this case, the array transmission control is performed based on the SRS having the transmission frequency band including the frequency band included in the RBG numbered 15 (the RBs numbered 46 and 47) which the communication terminal 2 having the terminal number E transmits in the unit period 360a immediately preceding the unit period 360b.

In the case where a communication terminal 2 which performs downlink communication by using a use downlink radio resource allocated from the downlink radio resources in a certain unit period 360 is transmitting an SRS having a transmission frequency band including a frequency band included in the frequency band of the use downlink radio resource in the certain unit period 360, the array transmission control is performed in each of the base stations 1 of the communication system 100 according to the present embodiment, based on the SRS. On the other hand, in the case where a communication terminal 2 which performs downlink communication by using a use downlink radio resource allocated from the downlink radio resources in a certain unit period 360 is not transmitting an SRS having a transmission frequency band including a frequency band included in the frequency band of the use downlink radio resource in the certain unit period 360, the array transmission control is performed, based on the SRS having the transmission frequency band including a frequency band included in the frequency band of the use downlink radio resource which the communication terminal 2 transmits in a unit period 360 previous to the certain unit period 360.

For the downlink communication in each of the base stations 1 with a communication terminal 2 by using a frequency band comprised of the RBGs numbered 0 through 2 which is included in the SRS untransmittable band (the RBs numbered 0 through 9) in a certain unit period 360 (the unit periods 360a and 360c in FIG. 16) where the SRS transmittable band 450 is on the high-frequency side, the array transmission control is performed, based on the SRS which the communication terminal 2 transmits in a unit period 360 immediately preceding the certain unit period 360. For the downlink communication in each of the base stations 1 with a communication terminal 2 by using a frequency band comprised of the SRS untransmittable band (the RBs numbered 40 through 49) and the RB numbered 39 adjacent thereto on the low-frequency side in a certain unit period 360 (the unit period 360b in FIG. 16) where the SRS transmittable band 450 is on the low-frequency side, the array transmission control is performed, based on the SRS which the communication terminal 2 transmits in a unit period 360 immediately preceding the certain unit period 360.

Null steering and beamforming are performed at the same time for the array transmission control according to the present embodiment. The communication section 13 updates the reception weights a plurality of times by using a sequential update algorithm such as RLS (Recursive Least-Squares) algorithm, for example, to determine the transmission weights, based on the reception weights after the completion of the update, whereby both the null steering and the beamforming are performed at the same time.

In the array transmission control according to the present embodiment, a transmission weight is determined, for example, for each RB. The transmission frequency band of the SRS transmitted from each communication terminal 2 in the present embodiment is comprised of four RBs. Accordingly, a transmission weight is determined for each of the four RBs. A transmission weight for a certain RB for the target communication terminal 2 is determined based on a reception weight after the reception weight is updated six times, based on six complex symbols constituting the SRS which the target communication terminal 2 transmits by using the certain RB. Twelve complex symbols are transmittable using a single RB because the single RB includes 12 subcarriers. However, the subcarriers which a single communication terminal 2 uses for the transmission of the SRS are disposed in the form of comb teeth in the frequency direction. Therefore, the SRS which a communication terminal 2 transmits by using a single RB is comprised of six complex symbols.

For the downlink communication with the target communication terminal 2 by using a use downlink radio resource including a single RB in the frequency direction in the array transmission control according to the present embodiment, the transmission weight determined based on the SRS which the target communication terminal 2 transmits by using the single RB is assigned, in principle, to a transmission signal to be transmitted using the use downlink radio resource.

For the downlink communication with the communication terminal 2 having the terminal number A in the unit period 360a by using the use downlink radio resource including the RB numbered 30 in the frequency direction, for example, in the aforementioned example of FIG. 16, a transmission weight determined based on the SRS which the communication terminal 2 having the terminal number A transmits in the unit period 360a by using the RB numbered 30 is assigned to a transmission signal to be transmitted using the use downlink radio resource.

For the downlink communication with the communication terminal 2 having the terminal number D in the second unit period 360b by using the use downlink radio resource including the RB numbered 42 in the frequency direction, a transmission weight determined based on the SRS which the communication terminal 2 having the terminal number D transmits in the immediately preceding unit period 360a by using the RB numbered 42 is assigned to a transmission signal to be transmitted using the use downlink radio resource.

There are, however, cases where a use downlink radio resource including a single RB adjacent on the low-frequency side or on the high-frequency side to the transmission frequency band of the SRS which a communication terminal 2 transmits in the frequency direction is assigned to the communication terminal 2 as stated above. In these cases, a transmission weight determined based on the SRS which the communication terminal 2 transmits by using a single RB adjacent to an RB included in the use downlink radio resource in the frequency direction, for example, is assigned to a transmission signal to be transmitted using the use downlink radio resource.

For the downlink communication with the communication terminal 2 having the terminal number F in the unit period 360a by using the use downlink radio resource including the RB numbered 9 adjacent on the low-frequency side to the transmission frequency band (the RBs numbered 10 through 13) of the SRS which the communication terminal 2 having the terminal number F transmits in the unit period 360a in the frequency direction, for example, in the aforementioned example of FIG. 16, a transmission weight determined based on the SRS which the communication terminal 2 having the terminal number F transmits in the unit period 360a by using the RB numbered 10 adjacent to the RB numbered 9 included in the use downlink radio resource in the frequency direction is assigned to a transmission signal to be transmitted using the use downlink radio resource.

For the downlink communication with a communication terminal 2 by using a use downlink radio resource including a certain RBG in the frequency direction, the array transmission control is performed in each of the base stations 1 of the communication system 100 according to the present embodiment as described above, based on the SRS having a transmission frequency band including a frequency band included in the certain RBG. Thus, each base station 1 is allowed to appropriately direct a beam related to the transmission directivity of the array antenna 110 toward a communication terminal 2 when performing the downlink communication with the communication terminal 2. In other words, when each base station 1 performs the downlink communication with the communication terminal 2 by using a use downlink radio resource including a certain RBG in the frequency direction, the frequency band of the use downlink radio resource substantially coincides with the transmission frequency band of the SRS transmitted from the communication terminal 2 for use in the array transmission control for the downlink communication. Thus, each base station 1 is allowed to appropriately direct a beam related to the transmission directivity of the array antenna 110 toward the communication terminal 2 when performing the downlink communication with the communication terminal 2.

Further, each of the base stations 1 of the communication system 100 according to the present embodiment makes the allocation of the use uplink radio resources for SRS to the communication terminals 2 and the allocation of the use downlink radio resources to the communication terminals 2, and performs the array transmission control, as stated above. For the downlink communication with the communication terminals 2, each of the base stations 1 is hence allowed to appropriately direct a null related to the transmission directivity of the array antenna 110 toward the communication terminals 2 which communicate with a neighboring base station 1 positioned in the neighborhood of each base station 1. This will be described below.

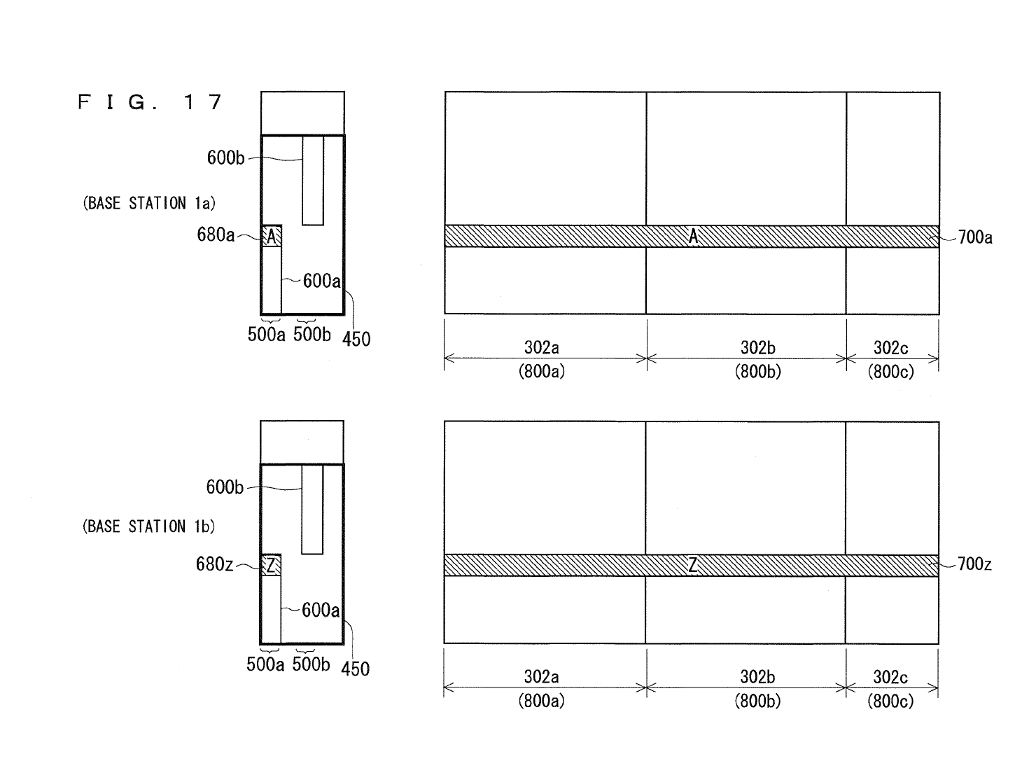

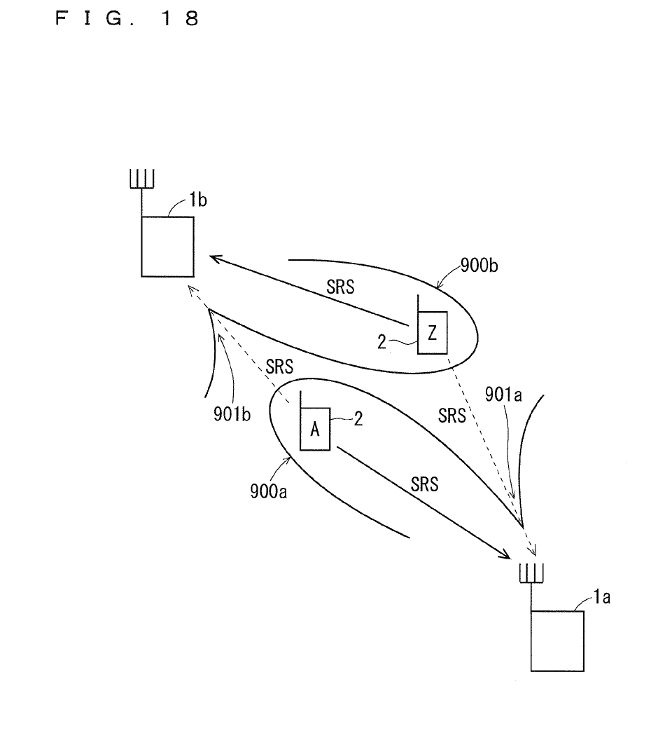

FIGS. 17 and 18 illustrate the appropriate control of beams and nulls related to the transmission directivity of the array antenna 110. FIG. 17 shows an example of the allocation of the use uplink radio resources for SRS and the use downlink radio resources in a base station 1a and a base station 1b positioned in the neighborhood of the base station 1a in the target unit period 360. Beams and nulls related to the transmission directivity in the base stations 1a and 1b in the target unit period 360 are shown in FIG. 18.

In the example of FIGS. 17 and 18, the base station 1a uses the use downlink radio resource 700a to perform downlink communication in the target unit period 360 with the communication terminal 2 having the terminal number A which transmits the SRS by using the use uplink radio resource for SRS 680a included in the first allocatable uplink radio resource for SRS 600a. The base station 1b uses a use downlink radio resource 700z to perform downlink communication with a communication terminal 2 having a terminal number Z which transmits the SRS by using a use uplink radio resource for SRS 680z included in the first allocatable uplink radio resource for SRS 600a. In the example of FIGS. 17 and 18, the use downlink radio resource 700a coincides with the use downlink radio resource 700z.

In the target unit period 360, when the use downlink radio resource 700a which the base station 1a uses for downlink communication coincides with the use downlink radio resource 700z which the base station 1b uses for downlink communication, the use uplink radio resource for SRS 680a for use in the transmission of the SRS which the base station 1a uses for array transmission control when performing the downlink communication using the use downlink radio resource 700a coincides with the use uplink radio resource for SRS 680z for use in the transmission of the SRS which the base station lb uses for array transmission control when performing the downlink communication using the use downlink radio resource 700z. For this reason, the SRS transmitted from the communication terminal 2 having the terminal number Z communicating with the base station 1b positioned in the neighborhood of the base station 1a is included as an interference wave component in the SRS which the base station 1a receives from the communication terminal 2 having the terminal number A in the use uplink radio resource for SRS 680a. Thus, when the base station 1a calculates a transmission weight, based on the SRS received from the communication terminal 2 having the terminal number A in the use uplink radio resource for SRS 680a, to assign the transmission weight to a transmission signal to be transmitted to the communication terminal 2 having the terminal number A by using the use downlink radio resource 700a, a beam 900a is directed toward the communication terminal 2 having the terminal number A and a null 901a is directed toward the communication terminal 2 having the terminal number Z communicating with the base station 1b as for the transmission directivity of the array antenna 110 in the case where the base station 1a transmits by using the use downlink radio resource 700a, as shown in FIG. 18. This allows the base station 1a to deliver the transmission signal to a communication terminal 2 for communication therewith with reliability and to suppress interference with a communication terminal 2 communicating with the neighboring base station 1b. From the viewpoint of the base station 1b, the base station 1a positioned in the neighborhood of the base station 1b directs a null toward the communication terminal 2 communicating with the base station 1b when communicating with a communication terminal 2.

On the other hand, the SRS transmitted from the communication terminal 2 having the terminal number A communicating with the base station 1a positioned in the neighborhood of the base station 1b is included as an interference wave component in the SRS which the base station 1b receives from the communication terminal 2 having the terminal number Z in the use uplink radio resource for SRS 680z. Thus, when the base station 1b calculates a transmission weight, based on the SRS received from the communication terminal 2 having the terminal number Z in the use uplink radio resource for SRS 680z, to assign the transmission weight to a transmission signal to be transmitted to the communication terminal 2 having the terminal number Z by using the use downlink radio resource 700z, a beam 900b is directed toward the communication terminal 2 having the terminal number Z and a null 901b is directed toward the communication terminal 2 having the terminal number A communicating with the base station 1a as for the transmission directivity of the array antenna 110 in the case where the base station 1b transmits the transmission signal by using the use downlink radio resource 700z. This allows the base station 1b to deliver the transmission signal to a communication terminal 2 for communication therewith with reliability and to suppress interference with a communication terminal 2 communicating with the neighboring base station 1a.

In this manner, each base station 1 is capable of directing a beam toward a communication terminal 2 for communication therewith and to direct a null toward a communication terminal 2 not for communication therewith, thereby controlling the beam and the null appropriately.

<Switching between 5-ms Cycle Transmission and Shortest Cycle Transmission>

In each base station 1 according to the present embodiment, when the number of communication terminals 2 with which the communication section 13 performs downlink communication is greater than the number of groups of 4 RBs (transmission frequency bandwidths of the SRS transmitted from the communication terminals 2) included in the frequency bandwidth of the allocatable uplink radio resource for SRS, the radio resource allocating section 122 allocates the use uplink radio resources for SRS to each communication terminal 2 so that each communication terminal 2 with which the communication section 13 performs downlink communication performs the 5-ms cycle transmission of the SRS. Five groups of 4 RBs are included in the frequency bandwidth of the allocatable uplink radio resource for SRS in the present embodiment because the frequency bandwidth corresponds to 20 RBs. Thus, when the number of communication terminals 2 with which the communication section 13 performs downlink communication is greater than 5, the communication section 13 according to the present embodiment causes each of the communication terminals 2 with which the communication section 13 performs downlink communication to perform the 5-ms cycle transmission of the SRS.

In each base station 1 according to the present embodiment, on the other hand, when the number of communication terminals 2 with which the communication section 13 performs downlink communication is not greater than the number of groups of 4 RBs included in the frequency bandwidth of the allocatable uplink radio resource for SRS, the radio resource allocating section 122 allocates the use uplink radio resources for SRS to each communication terminal 2 so that each communication terminal 2 with which the communication section 13 performs downlink communication performs the shortest cycle transmission of the SRS. In other words, when the number of communication terminals 2 with which the communication section 13 performs downlink communication is not greater than 5, the communication section 13 in each base station 1 causes each of the communication terminals 2 with which the communication section 13 performs downlink communication to perform the shortest cycle transmission of the SRS.

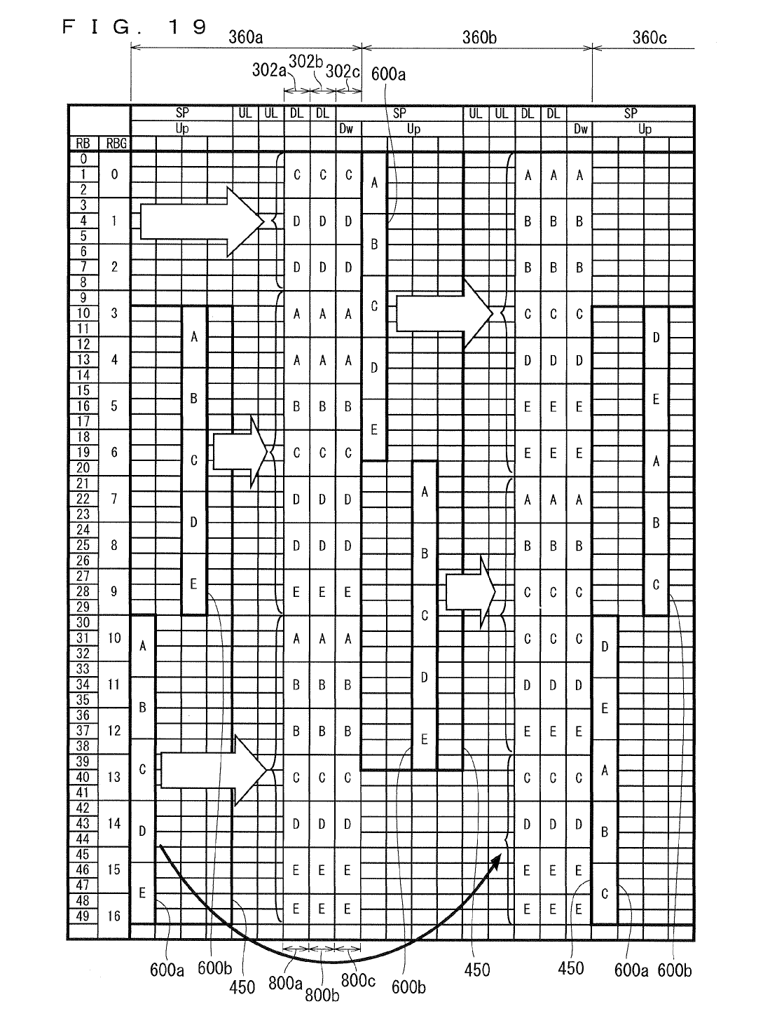

FIG. 19 is a diagram showing an example of the allocation of the use downlink radio resources to the communication terminals 2 with which the communication section 13 performs downlink communication in the case where the communication terminals 2 perform the shortest cycle transmission of the SRS. In the example of FIG. 19, the base station 1 performs downlink communication with the five communication terminal 2 having the terminal numbers A to E.

As shown in FIG. 19, when the number of communication terminals 2 with which the communication section 13 performs downlink communication is not greater than 5, the use uplink radio resources for SRS are allocated from both the first allocatable uplink radio resource for SRS 600a and the second allocatable uplink radio resource for SRS 600b in each unit period 360 to the communication terminals 2 with which the communication section 13 performs downlink communication in each unit period 360.

<About Method of Determining MCS>

In the communication system 100 according to the present embodiment, M MCSs (M≧2) representing different combinations of modulation schemes and code rates are specified. In LTE, 29 MCSs are specified. The M MCSs are ranked on a scale of 0 to (M−1). The higher the rank, the higher the instantaneous transmission throughput of the base station 1 which is determined by the combination of a modulation scheme and a code rate in a MCS corresponding to the rank. Thus, when the communication section 13 uses the MCS ranked (M−1)th to perform downlink communication, the instantaneous transmission throughput of the base station 1 is maximized. The MCS determining section 125 determines an MCS which the communication section 13 applies to a transmission signal to be transmitted to a communication terminal 2 from the M MCSs.

A single MCS is applied to a transmission signal to be transmitted to a single communication terminal 2 by using each of the downlink sub-frames 302, i.e. the first downlink sub-frame 302a, the second downlink sub-frame 302b and the third downlink sub-frame 302c, regardless of the frequency band of the transmission signal in the present embodiment. That is, a single MCS is determined for a single communication terminal 2 in each downlink sub-frame 302.

In the aforementioned example of FIG. 16, for example, the use downlink radio resource including the RBG numbered 10 in the frequency direction is allocated to the communication terminal 2 having the terminal number A in the first downlink sub-frame 302a of the unit period 360a. The MCS determining section 125 determines a single MCS to be applied to a transmission signal to be transmitted to the communication terminal 2 having the terminal number A by using this use downlink radio resource.

Also, the use downlink radio resource including the RBG numbered 0 in the frequency direction and the use downlink radio resource including the RBG numbered 13 in the frequency direction are allocated to the communication terminal 2 having the terminal number C in the second downlink sub-frame 302b of the unit period 360a. The MCS determining section 125 determines a single MCS to be applied to a transmission signal to be transmitted to the communication terminal 2 having the terminal number C by using these use downlink radio resources.

The MCS determining section 125 determines a single MCS to be applied to a transmission signal to be transmitted to the target communication terminal 2 by using a use downlink radio resource included in the downlink sub-frame 302, based on downlink transmission channel characteristics between the communication section 13 and the target communication terminal 2 in the entire frequency band of the use downlink radio resource. A method of determining the MCS is described in detail below.

Upon receipt of a signal from the base station 1, each communication terminal 2 in the present embodiment determines an SINR (Signal to Interference plus Noise power Ratio) for the reception signal for each RB. The SINR for each RB which is determined in each communication terminal 2 represents the downlink transmission channel characteristics between each communication terminal 2 and the communication section 13 in each RB. Each communication terminal 2 converts the determined SINR into a CQI (Channel Quality Indicator) to provide notification of the CQI to the base station 1.

When determining a single MCS to be applied to a transmission signal to be transmitted to the target communication terminal 2 by using a use downlink radio resource included in the downlink sub-frame 302, the MCS determining section 125 determines the average value of past CQIs in a plurality of RBs included in the frequency band of this use downlink radio resource in the target communication terminal 2. This average value of CQIs represents the downlink transmission channel characteristics between the target communication terminal 2 and the communication section 13 in the entire frequency band of this use downlink radio resource. The MCS determining section 125 determines a single MCS to be applied to a transmission signal to be transmitted to the target communication terminal 2 by using this use downlink radio resource, based on the average value of CQIs.

A correspondence table including a list of correspondences between possible values of CQIs determined in a communication terminal 2 and MCSs to be applied to a transmission signal to the communication terminal 2 in the case where the CQI in the communication terminal 2 has these values is stored in the MCS determining section 125 according to the present embodiment. This correspondence table is prepared for each communication terminal 2. The MCS determining section 125 identifies the MCS corresponding to the determined average value of CQIs by reference to the correspondence table for the target communication terminal 2 to determine the MCS as the MCS to be applied to the transmission signal to the target communication terminal 2.

The MCS to be applied to the transmission signal is adjusted in the present embodiment. A method of adjusting the MCS is described below. In the following description, the expression “downlink communication performed once” means the downlink communication between the base station 1 and a communication terminal 2 in a single downlink sub-frame 302.

Each time the downlink communication is performed once between each communication terminal 2 and the base station 1 in the present embodiment, each communication terminal 2 notifies the base station 1 about ACK/NACK information indicating whether data included in a transmission signal transmitted from the base station 1 via the downlink communication performed once is appropriately received or not. The MCS determining section 125 observes the ACK/NACK information about which notification is received from the target communication terminal 2 via the downlink communication performed Y times (Y 2) between the base station 1 and the target communication terminal 2 to calculate a reception error rate in the target communication terminal 2. The MCS determining section 125 updates the correspondence table for the target communication terminal 2 when the reception error rate for the target communication terminal 2 is high or low. The MCS determining section 125, on the other hand, does not update the correspondence table but maintains the correspondence table when the reception error rate for the target communication terminal 2 is appropriate.

When the reception error rate for the target communication terminal 2 is high or low, the MCS determining section 125 changes the values of CQIs or changes the MCSs corresponding to the values of CQIs for the correspondence table for the target communication terminal 2. For example, when the reception error rate for the target communication terminal 2 is high, that is, when the reception error rate is higher than a first threshold value, the MCS determining section 125 increases the values of CQIs listed in the correspondence table for the target communication terminal 2 by a predetermined value or changes the MCSs corresponding to the values of CQIs to move down in rank by one. When the reception error rate for the target communication terminal 2 is low, that is, when the reception error rate is lower than a second threshold value (less than the first threshold value), the MCS determining section 125 decreases the values of CQIs listed in the correspondence table for the target communication terminal 2 by a predetermined value or changes the MCSs corresponding to the values of CQIs to move up in rank by one.

In this manner, the correspondence table for use in determining the MCS to be applied to the transmission signal to a communication terminal 2 from the CQI in the communication terminal 2 is updated in the present embodiment, based on the result of the downlink communication between the base station 1 and the communication terminal 2. Each time the correspondence table is updated, the MCS determining section 125 identifies the MCS corresponding to the determined average value of CQIs by reference to the updated correspondence table to determine the identified MCS as the MCS to be applied to the transmission signal to the target communication terminal 2, thereby adjusting the MCS. This adjustment of the MCS is made in the base station 1 each time the downlink communication with the communication terminal 2 is performed Y times.

<Effects in Base Station According to Present Embodiment>

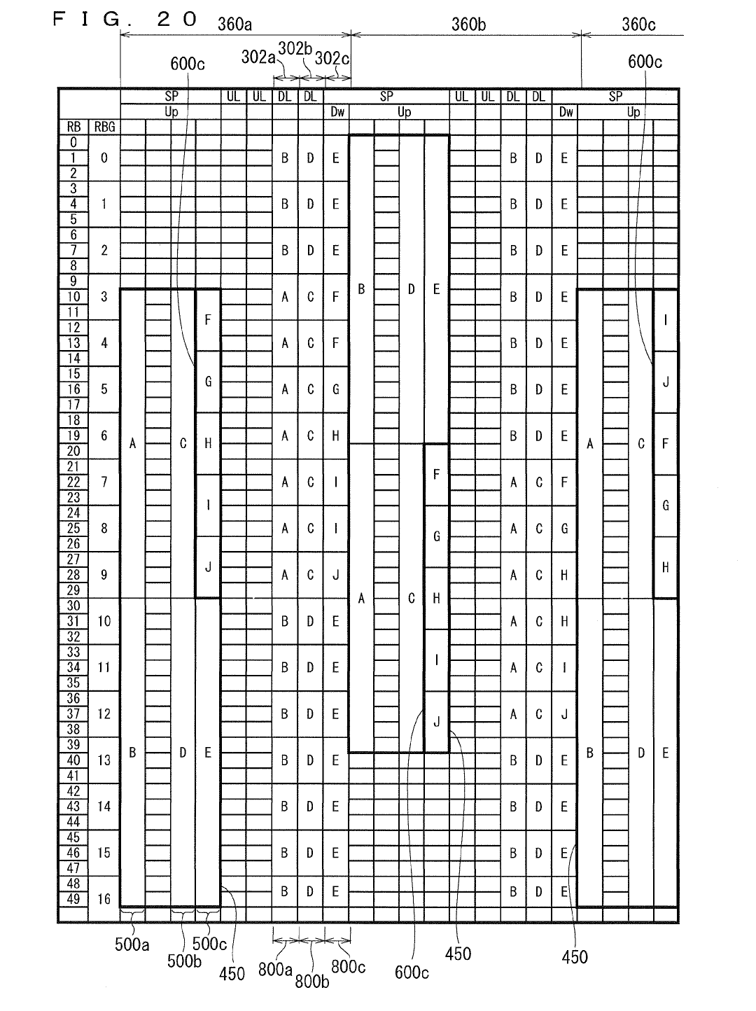

Next, effects in the base station 1 according to the present embodiment are described. Description is given on effects in the base station 1 according to the present embodiment while making a comparison between the base station 1 according to the present embodiment and a base station (referred to hereinafter as a “comparable base station”) which allocates the use uplink radio resources for SRS and the use downlink radio resources to the communication terminals 2 by a different method from that used in the base station 1 according to the present embodiment. First, the operation of the comparable base station is described with reference to FIG. 20.

FIG. 20 is a diagram showing an example of the allocation of the use uplink radio resources for SRS and the use downlink radio resources to the communication terminals 2 in the comparable base station. An example of the allocation of the use uplink radio resources for SRS and the use downlink radio resources to the ten communication terminals 2 having the terminal numbers A to J in the case where the comparable base station performs downlink communication with the ten communication terminals 2, as in FIG. 16 described above, is shown in FIG. 20.

<Method of Allocating Use Uplink Radio Resources for SRS in Comparable Base Station>

The comparable base station is capable of allocating the use uplink radio resources for SRS from the first uplink radio resource for SRS 500a and the second uplink radio resource for SRS 500b to the communication terminals 2, and is also capable of allocating the use uplink radio resources for SRS from an uplink radio resource (referred to hereinafter as a “third uplink radio resources for SRS 500c”) identified by the second uplink communication period for SRS 370b and the subcarriers SC1 in the form of comb teeth which are included in the SRS transmittable band 450 and usable for the transmission of the SRS1.

The transmission frequency bandwidth of the SRS for transmission from the communication terminals 2 which is used in the comparable base station is of two types: 20 RBs and 4 RBs. The comparable base station allocates the use uplink radio resources for SRS of 4 RBs from an uplink radio resource of 20 RBs (referred to hereinafter as a “4RB allocatable uplink radio resource for SRS 600c”) included in the third uplink radio resources for SRS 500c to a communication terminal 2 caused to transmit the SRS having a bandwidth of 4 RBs (referred to hereinafter as a “4RB-SRS”). Accordingly, the comparable base station is capable of transmitting the 4RB-SRS to a maximum of five communication terminals 2 in a single unit period 360. A communication terminal 2 which transmits the 4RB-SRS is referred to hereinafter as a “4RB terminal 2”.

The comparable base station, on the other hand, allocates a use uplink radio resource to a communication terminal 2 caused to transmit the SRS having a bandwidth of 20 RBs (referred to hereinafter as a “20RB-SRS”), the use uplink radio resource being one of the following: the uplink radio resource corresponding to 20 RBs on the low-frequency side included in the first uplink radio resource for SRS 500c, the uplink radio resource corresponding to 20 RBs on the high-frequency side included in the first uplink radio resource for SRS 500c, the uplink radio resource corresponding to 20 RBs on the low-frequency side included in the second uplink radio resource for SRS 500b, the uplink radio resource corresponding to 20 RBs on the high-frequency side included in the second uplink radio resource for SRS 500b, and the uplink radio resource included in the third uplink radio resource for SRS 500c and other than the 4RB allocatable uplink radio resource for SRS 600c. Accordingly, the comparable base station is capable of transmitting the 20RB-SRS to a maximum of five communication terminals 2 in a single unit period 360. A communication terminal 2 which transmits the 20RB-SRS is referred to hereinafter as a “20RB terminal 2”.

Like the aforementioned frequency bands of the first allocatable uplink radio resource for SRS 600a and the second allocatable uplink radio resource for SRS 600b, the frequency band of the 4RB allocatable uplink radio resource for SRS 600c is frequency-hopped for each of the unit periods 360. Specifically, as shown in FIG. 20, the frequency band of the 4RB allocatable uplink radio resource for SRS 600c is disposed alternately on the high-frequency side and on the low-frequency side in the SRS transmittable band 450 for each of the unit periods 360.

In the comparable base station, whether to cause the target communication terminal 2 to transmit the 4RB-SRS or the 20RB-SRS is determined based on the reception quality of a signal from the target communication terminal 2. Specifically, the comparable base station determines to cause the target communication terminal 2 to transmit the 4RB-SRS when the reception quality of the signal from the target communication terminal 2 does not satisfy a predetermined condition, and determines to cause the target communication terminal 2 to transmit the 20RB-SRS when the reception quality of the signal from the target communication terminal 2 satisfies the predetermined condition. In other words, the comparable base station allocates the use uplink radio resource for SRS of 4 RBs to the target communication terminal 2 when the reception quality of the signal from the target communication terminal 2 does not satisfy the predetermined condition, and allocates the use uplink radio resource for SRS of 20 RBs to the target communication terminal 2 when the reception quality of the signal from the target communication terminal 2 satisfies the predetermined condition. For example, the reception level (received power) of the signal from the communication terminal 2 may be used herein as the reception quality.

In this manner, the comparable base station decreases the transmission frequency bandwidth of the SRS for the target communication terminal 2 when the reception quality of the signal from the target communication terminal 2 is poor because of a great distance from the target communication terminal 2 and the like. This allows the target communication terminal 2 to concentrate power during the transmission of the SRS, so that the comparable base station receives the SRS more easily from the target communication terminal 2.

In the example of FIG. 20, the reception quality of signals from the communication terminals 2 having the terminal numbers A to E is good, so that the use uplink radio resources for SRS of 20 RBs are allocated to these communication terminal 2. On the other hand, the reception quality of signals from the communication terminals 2 having the terminal numbers F to J is not good, so that the use uplink radio resources for SRS of 4 RBs are allocated to these communication terminals 2.

In the comparable base station, the use uplink radio resources for SRS are allocated to the communication terminals 2 so that the transmission frequency band of the 20RB-SRS transmitted from the communication terminals 2 is frequency-hopped within the SRS transmittable band 450. As shown in FIG. 20, the transmission frequency band of the 20RB-SRS transmitted from the communication terminals 2 having the terminal numbers A to E is disposed alternately on the high-frequency side and on the low-frequency side in the SRS transmittable band 450 for each of the unit periods 360 (at intervals of 5 ms).

Also in the comparable base station, the use uplink radio resources for SRS are allocated to the communication terminals 2 so that the transmission frequency band of the 4RB-SRS transmitted from the communication terminals 2 is frequency-hopped within the frequency band of the 4RB allocatable uplink radio resource for SRS 600c. As shown in FIG. 20, the transmission frequency band of the 4RB-SRS transmitted from the communication terminals 2 having the terminal numbers F to J is frequency-hopped within the frequency band of the 4RB allocatable uplink radio resource for SRS 600c at intervals of two unit periods 360 (at intervals of 10 ms) in a manner similar to the SRS band 650 frequency-hopped in the aforementioned frequency band of the first allocatable uplink radio resource for SRS 600a or the second allocatable uplink radio resource for SRS 600b (with reference to FIGS. 10 and 11).

<Method of Allocating Use Downlink Radio Resources for SRS in Comparable Base Station>

For the downlink communication with a communication terminal 2 transmitting the SRS by using part of the first uplink radio resource for SRS 500a, the comparable base station allocates the use downlink radio resources from the first downlink sub-frame 302a to the communication terminal 2. In the example of FIG. 20, the use downlink radio resources are allocated from the first downlink sub-frame 302a to the communication terminals 2 having the terminal numbers A and B transmitting the SRS by using part of the first uplink radio resource for SRS 500a.

For the downlink communication with a communication terminal 2 transmitting the SRS by using part of the second uplink radio resource for SRS 500b, the comparable base station allocates the use downlink radio resources from the second downlink sub-frame 302b to the communication terminal 2. In the example of FIG. 20, the use downlink radio resources are allocated from the second downlink sub-frame 302b to the communication terminals 2 having the terminal numbers C and D transmitting the SRS by using part of the second uplink radio resource for SRS 500b.

For the downlink communication with a communication terminal 2 transmitting the SRS by using part of the third uplink radio resources for SRS 500c, the comparable base station allocates the use downlink radio resources from the third downlink sub-frame 302c to the communication terminal 2. In the example of FIG. 20, the use downlink radio resources are allocated from the third downlink sub-frame 302c to the communication terminals 2 having the terminal numbers E to J transmitting the SRS by using part of the third uplink radio resources for SRS 500c.

Other rules in allocating the use downlink radio resources to the communication terminals 2 in the comparable base station are similar to those in the base station 1 according to the present embodiment.

Next, description is given on effects in the base station 1 while making a comparison between the base station 1 according to the present embodiment and the comparable base station.

<Improvement in Reception Performance of SRS>

The base station 1 according to the present embodiment allocates the use uplink radio resources for SRS having a narrow bandwidth of 4 RBs (the smallest one of a plurality of bandwidths that can be set as the transmission frequency band of the SRS) to the communication terminals 2. This allows the communication terminals 2 to concentrate power during the transmission of the SRS. Thus, the base station 1 appropriately receives the SRS from the communication terminals 2. This achieves an improvement in performance of the base station 1.

<Simplification of Transmission Control of SRS>

When the reception quality of a signal from a communication terminal 2 transmitting the 20RB-SRS is degraded, it is necessary for the comparable base station to transmit the SRS control data to the communication terminal 2 (with reference to FIG. 12) to change the SRS transmitted from the communication terminal 2 from the 20RB-SRS to the 4RB-SRS. In other words, it is necessary to change the transmission frequency bandwidth of the SRS transmitted from the communication terminal 2 from 20 RBs to 4 RBs. Thus, the transmission control of the SRS over the communication terminal 2 is complicated in the comparable base station.

In the base station 1 according to the present embodiment, on the other hand, the bandwidth of the SRS transmitted from each communication terminal 2 has a small value (4 RBs). It is hence unnecessary for the base station 1 to change the transmission frequency bandwidth of the SRS transmitted from a communication terminal 2, depending on the reception quality of the signal from the communication terminal 2. This achieves the simplification of the transmission control of the SRS over the communication terminal 2 in the base station 1.

<Insurance of Fairness of Downlink Communication>

In the comparable base station, as stated above, there are cases where different values of the transmission frequency bandwidth of the SRS are set for a plurality of communication terminals 2. Specifically, the transmission frequency bandwidth of the SRS is set to 20 RBs for a communication terminal 2, whereas the transmission frequency bandwidth of the SRS is set to 4 RBs for another communication terminal 2. Thus, when the use downlink radio resources including a frequency band which is substantially the same as the transmission frequency band of the SRS transmitted from each communication terminal 2 in the frequency direction are allocated to each communication terminal 2 for the purpose of allocating as many use downlink radio resources as possible to each communication terminal 2 while appropriately performing the array transmission control, a difference in use downlink radio lease between the communication terminals 2 increases to result in decreased fairness of the downlink communication between the communication terminals 2.

In the base station 1 according to the present embodiment, on the other hand, the same value (4 RBs) of the transmission frequency bandwidth of the SRS is set for the plurality of communication terminals 2. Thus, when the use downlink radio resources including a frequency band which is substantially the same as the transmission frequency band of the SRS transmitted from each communication terminal 2 in the frequency direction are allocated to each communication terminal 2, a difference in use downlink radio lease between the communication terminals 2 is decreased. This improves the fairness of the downlink communication between the communication terminals 2.

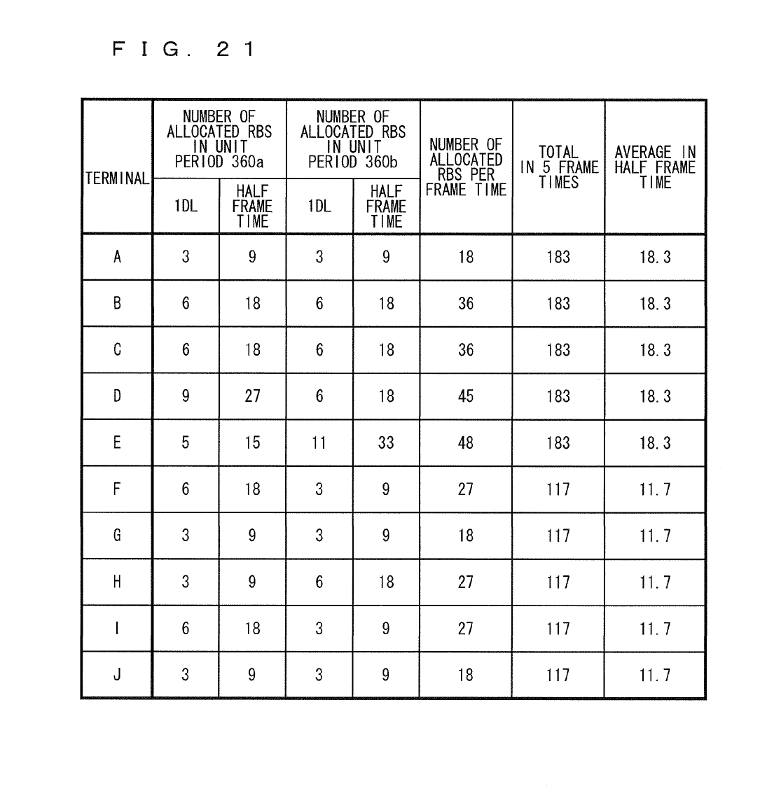

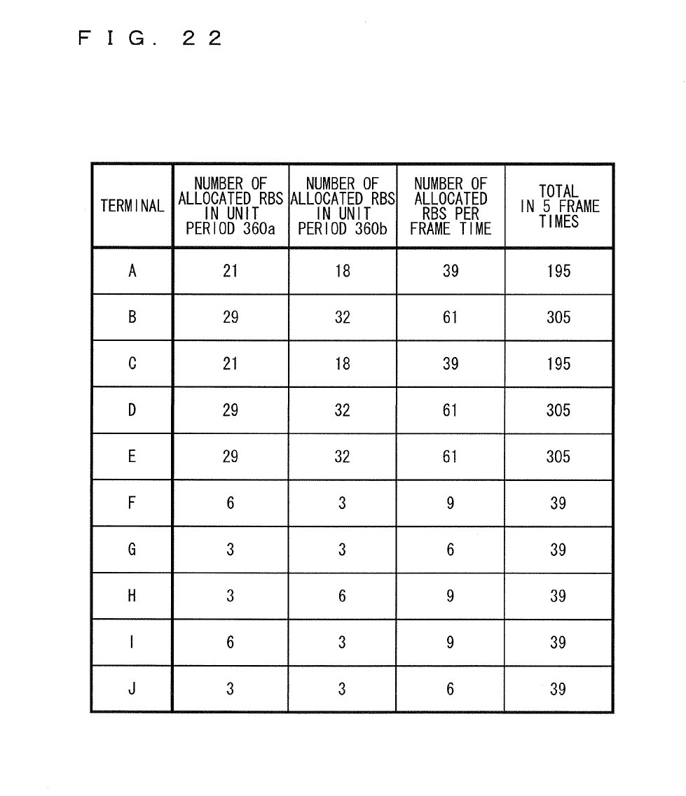

FIG. 21 is a table showing the amounts of use downlink radio resources in the communication terminals 2 in the case where the base station 1 according to the present embodiment allocates the use downlink radio resources to the communication terminals 2 as in the aforementioned example of FIG. 16. FIG. 22 is a table showing the amounts of use downlink radio resources in the communication terminals 2 in the case where the comparable base station allocates the use downlink radio resources to the communication terminals 2 as in the aforementioned example of FIG. 20.

In FIG. 21, “1 DL” in “Number of Allocated RBs in Unit Period 360a” denotes the number of resource blocks allocated by the base station 1 to each communication terminal 2 as the use downlink radio resources in a single downlink sub-frame 302 included in a unit period 360a, and “Half Frame Time” in “Number of Allocated RBs in Unit Period 360a” denotes the number of resource blocks allocated by the base station 1 to each communication terminal 2 as the use downlink radio resources in a unit period 360a. The number of resource blocks shown in FIGS. 21 and 22 does not represent the number of frequency bands of the resource blocks, but represents the number of resource blocks defined as regions including a frequency bandwidth of 180 kHz in the frequency direction and including 7 symbol periods 304 in the time direction.

Also in FIG. 21, “1 DL” in “Number of Allocated RBs in Unit Period 360b” denotes the number of resource blocks allocated by the base station 1 to each communication terminal 2 as the use downlink radio resources in a single downlink sub-frame 302 included in a unit period 360b, and “Half Frame Time” in “Number of Allocated RBs in Unit Period 360b” denotes the number of resource blocks allocated by the base station 1 to each communication terminal 2 as the use downlink radio resources in a unit period 360b.

Also in FIG. 21, “Number of Allocated RBs per Frame Time” denotes the number of resource blocks allocated by the base station 1 to each communication terminal 2 as the use downlink radio resources in a period of one frame time comprised of two unit periods 360a and 360b. In FIG. 21, “Total in 5 Frame Times” denotes the number of resource blocks allocated by the base station 1 to each communication terminal 2 as the use downlink radio resources in a period corresponding to a lapse of five frame times from the leading end of a unit period 360a, i.e. in a period comprised of ten consecutive unit periods 360 including a unit period 360a at its leading end, and “Average in Half Frame Time” denotes a value obtained by dividing the number of resource blocks by the number of unit periods 360 included in that period, i.e. by “10”. In other words, “Average in Half Frame Time” denotes the average number of resource blocks allocated by the base station 1 to each communication terminal 2 as the use downlink radio resources per half frame time (per unit period 360).

In FIG. 22, “Number of Allocated RBs in Unit Period 360a” denotes the number of resource blocks allocated by the comparable base station to each communication terminal 2 as the use downlink radio resources in a unit period 360a, and “Number of Allocated RBs in Unit Period 360b” denotes the number of resource blocks allocated by the comparable base station to each communication terminal 2 as the use downlink radio resources in a unit period 360b. Also in FIG. 22, “Number of Allocated RBs per Frame Time” denotes the number of resource blocks allocated by the base station 1 to each communication terminal 2 as the use downlink radio resources in a period of one frame time comprised of the unit periods 360a and 360b. In FIG. 22, “Total in 5 Frame Times” denotes the number of resource blocks allocated by the comparable base station to each communication terminal 2 as the use downlink radio resources in a period corresponding to a lapse of five frame times from the leading end of the unit period 360a.

As shown in FIG. 22, wide variation in the number of resource blocks allocated as the use downlink radio leases arises between the communication terminals 2 having the terminal numbers A to J communicating with the comparable base station. The fairness of the downlink communication between the communication terminals 2 having the terminal numbers A to J is not sufficiently insured.

As shown in FIG. 21, on the other hand, little variation in the number of resource blocks allocated as the use downlink radio leases arises between the communication terminals 2 having the terminal numbers A to J communicating with the base station 1 according to the present embodiment 1. The fairness of the downlink communication between the communication terminals 2 having the terminal numbers A to J is insured. In particular, the communication terminals 2 having the terminal numbers A to E to which the use uplink radio resources for SRS are allocated from the first allocatable uplink radio resource for SRS 600a are equal to each other in the average number of resource blocks (18.3 resource blocks) allocated to each communication terminal 2 as the use downlink radio resources in a single unit period 360 to achieve a dramatic improvement in fairness. Likewise, the communication terminals 2 having the terminal numbers F to J to which the use uplink radio resources for SRS are allocated from the second allocatable uplink radio resource for SRS 600b are equal to each other in the average number of resource blocks (11.7 resource blocks) allocated to each communication terminal 2 as the use downlink radio resources in a single unit period 360 to achieve a dramatic improvement in fairness.

<Suppression of Decrease in Transmission Throughput in Base Station>

The base station 1 according to the present embodiment allocates the use uplink radio resources for SRS of 4 RBs to the communication terminals 2. From the viewpoint of a single downlink sub-frame 302, the use downlink radio resources allocatable to the communication terminals 2 to which the use uplink radio resources for SRS of 4 RBs are allocated are less in number than those allocated to the communication terminals 2 to which the use uplink radio resources for SRS of 20 RBs are allocated.

For the downlink communication with a communication terminal 2 in a unit period 360, however, the base station 1 according to the present embodiment allocates the use downlink radio resources to the communication terminal 2 from the three downlink sub-frames 302 included in the unit period 360. Thus, a large number of use downlink radio resources are allocatable to the communication terminal 2 from the viewpoint of the whole unit periods 360. This suppresses the decrease in transmission throughput for the communication terminals 2 in the base station 1 which results from the allocation of the narrow-band use uplink radio resources for SRS to the communication terminals 2.

<Effective Use of Downlink Radio Resources>

The comparable base station is capable of transmitting the 4RB-SRS to five communication terminals 2 and transmitting the 20RB-SRS to five communication terminals 2 at the maximum in each unit period 360. Thus, the comparable base station is capable of performing downlink communication with five 4RB terminals 2 and five 20RB terminals 2 at the maximum in each unit period 360, as shown in FIG. 20 described above.

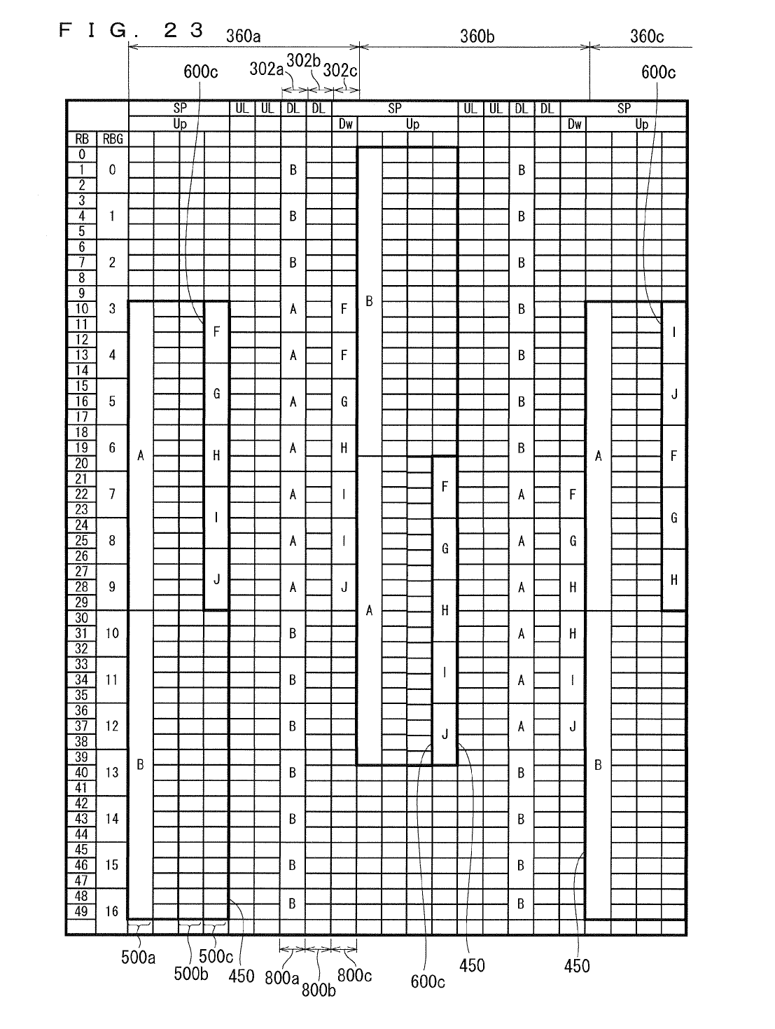

There are ten communication terminals 2 for communication with the comparable base station. However, if the number of communication terminals 2 transmitting the 20RB-SRS is less than five and the number of communication terminals 2 transmitting the 4RB-SRS is not less than six, only not more than nine communication terminals 2 are allowed to transmit the SRS in each unit period 360 because only five communication terminals 2 at the maximum are allowed to transmit the 4RB-SRS in each unit period 360. This gives rise to unused radio resources in the uplink radio resources (first to third uplink radio resources for SRS 500a to 500c) allocatable as the use uplink radio resources for SRS to the communication terminals 2. As a result, this gives rise to unused downlink radio resources in the first to third downlink sub-frames 302a to 302b in each unit period 360. FIG. 23 shows such a state.

Of the ten communication terminals 2 having the terminal numbers A to J for communication in the example of FIG. 23, the two communication terminals 2 having the terminal numbers A and B are communication terminals 2 which transmit the 20RB-SRS, and the eight communication terminals 2 having the terminal numbers C to J are communication terminals 2 which transmit the 4RB-SRS. Of the communication terminals 2 having the terminal numbers C to J, only the five communication terminals 2 having the terminal numbers F to J are those to which the use downlink radio resources are allocated.

In the example of FIG. 23, no use uplink radio resources for SRS are allocated to the communication terminals 2 from the entire region of the second uplink radio resource for SRS 500b and a partial region of the third uplink radio resources for SRS 500c. For this reason, the entire region of the second sub-frame 302b and a partial region of the third sub-frame 302c are not used for downlink communication. Therefore, the effective use of the downlink radio resources cannot be achieved.

On the other hand, the base station 1 according to the present embodiment 1 allocates the use uplink radio resources for SRS of 4 RBs to the communication terminals 2. When ten communication terminals 2 for communication are present, the base station 1 is capable of transmitting the SRS to all of the communication terminals 2. As shown in FIG. 16 described above, the entire regions of the first downlink sub-frame 302a, the second downlink sub-frame 302b and the third downlink sub-frame 303c are used for downlink communication. This achieves the effective use of the downlink radio resources.

Also, the comparable base station is capable of allocating the use uplink radio resources to the communication terminal 2 which transmit the 4RB-SRS only from uplink radio resources of 20 RBs (the 4RB allocatable uplink radio resource for SRS 600c) included in the third uplink radio resource for SRS 500c.

On the other hand, the base station 1 according to the present embodiment is capable of allocating the use uplink radio resources to the communication terminals 2 which transmit the 4RB-SRS from both the first allocatable uplink radio resource for SRS 600a and the second allocatable uplink radio resource for SRS 600b (the shortest cycle transmission), as shown in FIG. 19 described above, when the number of communication terminal 2 for communication is not more than five. Thus, when the number of communication terminal 2 for communication is not more than five, an increased number of use downlink radio resources are allocated to the communication terminals 2 in the base station 1 according to the present embodiment. This achieves the effective use of the downlink radio resources.

<Setting of Appropriate MCS>

In the comparable base station, there are cases where the use uplink radio resources for SRS of 20 RBs are allocated to the communication terminals 2. When a wide-band use uplink radio resource for SRS is allocated to a communication terminal 2 in this manner, a wide-band use downlink radio resource is allocated to the communication terminal 2 from the single downlink sub-frame 302. In the aforementioned example of FIG. 20, the wide-band use uplink radio resources for SRS are allocated from the single downlink sub-frame 302 to the communication terminals 2 having the terminal numbers A to E to which the wide-band use uplink radio resources for SRS are allocated.

When the wide-band use downlink radio resources are allocated to the communication terminals 2 in this manner, there are cases where the downlink transmission channel characteristics between the communication terminals 2 and the comparable base station in the frequency band of the use downlink radio resources varies widely due to frequency selective fading. That is, a frequency band in which the downlink transmission channel characteristics between the communication terminals 2 and the comparable base station is good is included in the frequency band of the wide-band use downlink radio resources in some cases, and a frequency band in which the downlink transmission channel characteristics is not good is included in the frequency band of the wide-band use downlink radio resources in other cases.

If variation arises in the downlink transmission channel characteristics in the frequency band of the use downlink radio resources when a single MCS to be applied to the transmission signal to be transmitted to the target communication terminal 2 by using the use downlink radio resources is determined based on the downlink transmission channel characteristics between the comparable base station and the target communication terminal 2 in the entire frequency band of the use downlink radio resource as mentioned above, the downlink transmission channel characteristics are degraded from the viewpoint of the entire frequency band of the use downlink radio resources although the downlink transmission channel characteristics are good in part of the frequency band of the use downlink radio resources. For this reason, a low-ranked MCS is applied as the MCS to be applied to the transmission signal to be transmitted to the target communication terminal 2 by using the use downlink radio resources.

In the base station 1 according to the present embodiment, on the other hand, the use uplink radio resources for SRS of 4 RBs are allocated to each of the communication terminals 2. Thus, the narrow-band use downlink radio resources are allocated from the single downlink sub-frame 302 to each of the communication terminals 2, as shown in FIG. 16 described above. This suppresses variation in the downlink transmission channel characteristics between the communication terminals 2 and the base station 1 in the frequency band of the use downlink radio resources allocated from the single downlink sub-frame 302 to the communication terminals 2. Thus, an appropriately ranked MCS is determined as the MCS to be applied to the transmission signal to be transmitted to the communication terminals 2 by using the use downlink radio resources.

<Shortening of Adjustment Time of MCS>

In the base station 1 according to the present embodiment, the MCS to be applied to the transmission signal to be transmitted to a communication terminal 2 is adjusted each time the downlink communication with the communication terminal 2 is performed Y times. In other words, the process of performing the downlink communication Y times is required to adjust the MCS once.

In the comparable base station, the use downlink radio resources are allocated to a single communication terminal 2 only from a single downlink sub-frame 302 in a single unit period 360. Thus, when the downlink communication with the target communication terminal 2 is performed in each unit period 360, the downlink communication is performed between the comparable base station and the target communication terminal 2 once per unit period 360, i.e. once every 5 ms. In this case, the adjustment of the MCS to be applied to the transmission signal to be transmitted to the target communication terminal 2 is made at intervals of (5×Y) ms. In other words, (5×Y) ms is required as the adjustment time of the MCS.

In the base station 1 according to the present embodiment, on the other hand, the use downlink radio resource is allocated to a single communication terminal 2 from each of three downlink sub-frames 302 in a single unit period 360. Thus, when the downlink communication with the target communication terminal 2 is performed in each unit period 360, the downlink communication is performed between the base station 1 and the target communication terminal 2 three times per unit period 360, i.e. three times every 5 ms. In this case, the adjustment of the MCS to be applied to the transmission signal to be transmitted to the target communication terminal 2 is made at intervals of ((5×Y)/3) ms. In other words, ((5×Y)/3) ms is required as the adjustment time of the MCS. This adjustment time of the MCS is one-third the adjustment time of the MCS in the comparable base station.

In the base station 1 according to the present embodiment, the use downlink radio resources are allocated to a single communication terminal 2 from three downlink sub-frames 302 in a single unit period 360 in this manner. This shortens the adjustment time of the MCS to thereby improve the transmission performance of the base station 1.

<Effects Obtained When Communication Terminal Performing Downlink Communication is Replaced>

The base station 1 according to the present embodiment is capable of performing downlink communication with only a maximum of ten communication terminals 2 in each unit period 360. When the number of communication terminals 2 for downlink communication exceeds ten, it is hence necessary to determine ten communication terminals 2 out of the communication terminals 2 for communication as those to which the use downlink radio resources are to be allocated. The radio resource allocating section 122 of the base station 1 determines the priority of downlink communication (referred to hereinafter as a “downlink priority”) for each of the communication terminals 2, based on proportional fairness and the like. When the number of communication terminals 2 for communication is more than ten, the radio resource allocating section 122 selects ten communication terminals 2 having the top-ten downlink priorities out of the aforementioned more than ten communication terminals 2 to allocate the use downlink radio resources to the ten selected communication terminals 2. When a communication terminal 2 having a downlink priority lower than the tenth downlink priority from the top of the downlink priorities of the communication terminals 2 for communication arises among the ten communication terminals 2 with which the base station 1 is currently performing downlink communication, the replacement of the communication terminal 2 performing the downlink communication (the communication terminal 2 to which the use downlink radio resources are to be allocated) is made.

When data transmitted from the base station 1 to a communication terminal 2 is not appropriately received by the communication terminal 2, i.e. when a reception error arises in the communication terminal 2, the base station 1 according to the present embodiment transmits the data again to the communication terminal 2. The base station 1 is capable of identifying whether a reception error has arisen in a communication terminal 2 or not, based on the aforementioned ACK/NACK information transmitted from the communication terminal 2.

As will be understood from the aforementioned description, the null steering in the base station 1 during the downlink communication with a communication terminal 2 involves the need for the communication terminal 2 to be transmitting the SRS by using at least one of the first allocatable uplink radio resource for SRS 600a and the second allocatable uplink radio resource for SRS 600b. If the target communication terminal 2 is replaced with another communication terminal 2 because of the decrease in the downlink priority of the target communication terminal 2 to no longer transmit the SRS before the base station 1 transmits the data again to the target communication terminal 2 where a reception error arises, the base station 1 can no longer perform the null steering when transmitting the data again to the target communication terminal 2.

In the unit period 360 in which the SRS transmittable band 450 is disposed on the high-frequency side in the system band as shown in FIG. 16 described above, a maximum of nine resource blocks are allocated as the use downlink radio resources to a single communication terminal 2 in a single downlink sub-frame 302. In the example of FIG. 16, nine resource blocks are allocated as the use downlink radio resources to the communication terminal 2 having the terminal number D in a single downlink sub-frame 302 in the unit period 360a. Thus, there are cases where data corresponding to a maximum of nine resource blocks is transmitted to a communication terminal 2 in a single downlink sub-frame 302 in the unit period 360 in which the SRS transmittable band 450 is disposed on the high-frequency side in the system band. If the reception error of the data corresponding to nine resource blocks arises in the communication terminal 2, it is necessary to transmit the data corresponding to nine resource blocks again. If the communication terminal 2 is replaced with another communication terminal 2 before the data is transmitted again, it is impossible to perform the null steering when transmitting the data corresponding to nine resource blocks again.

In the unit period 360 in which the SRS transmittable band 450 is disposed on the low-frequency side in the system band, a maximum of eleven resource blocks are allocated as the use downlink radio resources to a single communication terminal 2 in a single downlink sub-frame 302. In the example of FIG. 16, eleven resource blocks are allocated as the use downlink radio resources to the communication terminal 2 having the terminal number E in a single downlink sub-frame 302 in the unit period 360b. Thus, there are cases where data corresponding to a maximum of eleven resource blocks is transmitted again to a communication terminal 2 in a single downlink sub-frame 302 in the unit period 360 in which the SRS transmittable band 450 is disposed on the low-frequency side in the system band. If the reception error of the data corresponding to eleven resource blocks arises in the communication terminal 2, it is necessary to transmit the data corresponding to eleven resource blocks again. If the communication terminal 2 is replaced with another communication terminal 2 before the data is transmitted again, it is impossible to perform the null steering when transmitting the data corresponding to eleven resource blocks again.

In the unit period 360 in which the SRS transmittable band 450 is disposed on the high-frequency side in the system band as shown in FIG. 20 described above, on the other hand, the comparison base station allocates a maximum of 29 resource blocks as the use downlink radio resources to a single communication terminal 2 in a single downlink sub-frame 302. In the example of FIG. 20, 29 resource blocks are allocated as the use downlink radio resources to the communication terminal 2 having the terminal number B in a single downlink sub-frame 302 in the unit period 360a. Thus, there are cases where data corresponding to a maximum of 29 resource blocks is transmitted to a communication terminal 2 in a single downlink sub-frame 302 in the unit period 360 in which the SRS transmittable band 450 is disposed on the high-frequency side in the system band. In some cases, it is impossible to perform the null steering when transmitting the data corresponding to 29 resource blocks again.

In the unit period 360 in which the SRS transmittable band 450 is disposed on the low-frequency side in the system band as shown in FIG. 20, the comparison base station allocates a maximum of 32 resource blocks as the use downlink radio resources to a single communication terminal 2 in a single downlink sub-frame 302. In the example of FIG. 20, 32 resource blocks are allocated as the use downlink radio resources to the communication terminal 2 having the terminal number B in a single downlink sub-frame 302 in the unit period 360b. Thus, there are cases where data corresponding to a maximum of 32 resource blocks is transmitted to a communication terminal 2 in a single downlink sub-frame 302 in the unit period 360 in which the SRS transmittable band 450 is disposed on the low-frequency side in the system band. In some cases, it is impossible to perform the null steering when transmitting the data corresponding to 32 resource blocks again.

In this manner, the base station 1 according to the present embodiment is capable of reducing the amount of data to be transmitted again to a communication terminal 2. Thus, the amount of data in which the null steering is not performed during the transmission thereof even in the case where it is impossible to perform the null steering when transmitting the data to the communication terminal 2 again. This improves the transmission performance of the base station 1.

<Various Modifications>

<First Modification>

Although only 4 RBs are used as the transmission frequency bandwidth of the SRS for transmission from the communication terminals 2 in the aforementioned example, 20 RBs may be used as the transmission frequency bandwidth of the SRS to achieve the effective use of the downlink radio resources, depending on the number of communication terminals 2 for communication.

For example, when the number of communication terminals 2 for communication is one and the reception quality of a signal from the communication terminal 2 is good, the use uplink radio resources for SRS of 20 RBs are allocated to the communication terminal 2. At this time, the use uplink radio resources for SRS may be allocated to the communication terminal 2 from one of the first allocatable uplink radio resource for SRS 600a and the second allocatable uplink radio resource for SRS 600b. Alternatively, the use uplink radio resources for SRS may be allocated to the communication terminal 2 from both of the first allocatable uplink radio resource for SRS 600a and the second allocatable uplink radio resource for SRS 600b to cause the communication terminal 2 to perform the shortest cycle transmission. This allows more use downlink radio resources to be allocated to the communication terminal 2, thereby achieving the effective use of the downlink radio resources.

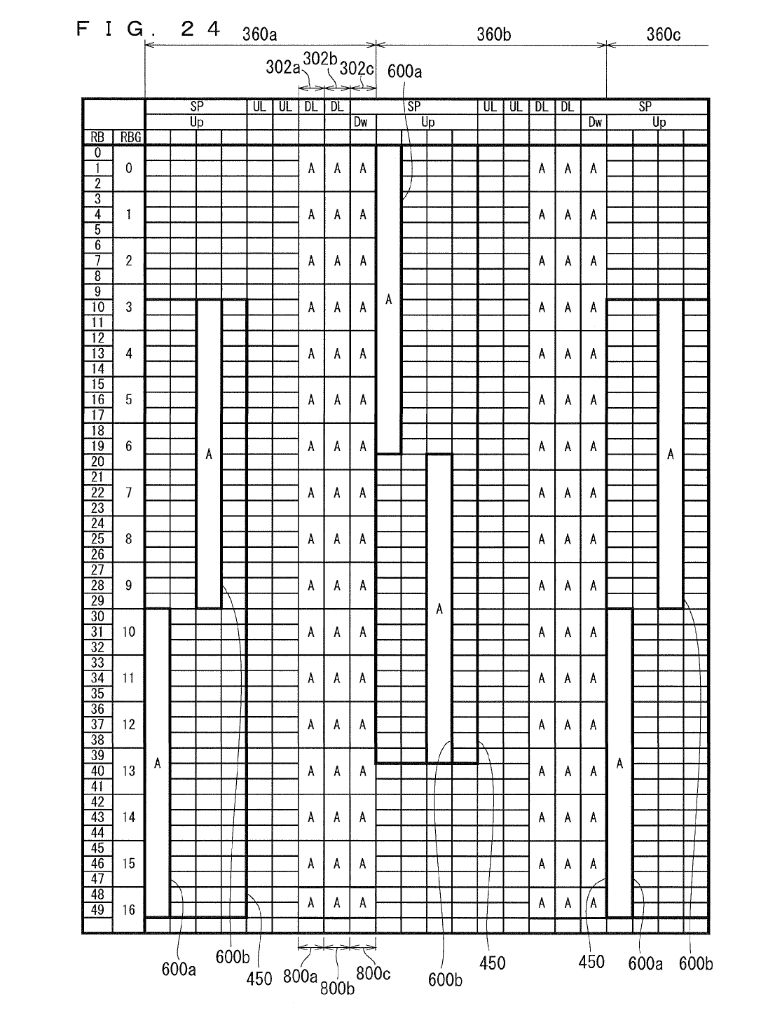

When the number of communication terminals 2 for communication is one and the use uplink radio resources for SRS of 20 RBs are allocated to the communication terminal 2 from both of the first allocatable uplink radio resource for SRS 600a and the second allocatable uplink radio resource 600b for SRS, all downlink radio resources may be allocated as the use downlink radio resources to the communication terminal 2, as shown in FIG. 24. In other words, the entire region of the system band may be used even when there is only one communication terminal 2 for communication.

In the comparable base station, on the other hand, two communication terminals 2 which transmit the 20RB-SRS are necessary in order to use the entire region of the system band for the downlink communication, as will be understood from FIG. 23 described above. In other words, the entire region of the system band cannot be used for the downlink communication, when the number of communication terminals 2 for communication is one.

In this manner, the present modification allows the use of the entire region of the system band even when the number of communication terminals 2 for communication is one. This achieves the effective use of the downlink radio resources.

<Second Modification>

As shown in FIG. 21 described above, the average number of resource blocks allocated as the use downlink radio resources per half frame time (per unit period 360) to the communication terminals 2 (the communication terminals 2 having the terminal numbers A to E) to which the use uplink radio resources for SRS are allocated from the first allocatable uplink radio resource for SRS 600a whose frequency band performs the end hopping is greater than that allocated to the communication terminals 2 (the communication terminals 2 having the terminal numbers F to J) to which the use uplink radio resources for SRS are allocated from the second allocatable uplink radio resource for SRS 600b whose frequency band performs the intermediate hopping.

In this manner, more use downlink radio resources may be allocated to the communication terminals 2 to which the use uplink radio resources for SRS are allocated from the first allocatable uplink radio resource for SRS 600a than to the communication terminals 2 to which the use uplink radio resources for SRS are allocated from the second allocatable uplink radio resource for SRS 600b. This is because the use downlink radio resources are allocated not only from the downlink radio resource in a certain unit period 360 but also from the downlink radio resource in the unit period 360 next to the certain unit period 360 to the communication terminal 2 (the consecutive-allocation terminal 2) which transmits the SRS in the frequency band of the first allocatable uplink radio resource for SRS 600a in the certain unit period 360 by using the frequency band included in the partial frequency band 601a not included in the SRS transmittable band 450 in the next unit period 360, as stated above (with reference to FIG. 15).

The radio resource allocating section 122 according to the present modification determines whether the use uplink radio resources for SRS are to be allocated to a communication terminal 2 from the first allocatable uplink radio resource for SRS 600a or the second allocatable uplink radio resource for SRS 600b, based on the amount of data to be transmitted to the communication terminal 2. This allows the allocation of the use uplink radio resources for SRS from the first allocatable uplink radio resource for SRS 600a to a communication terminal 2 to which a large amount of data is to be transmitted. As a result, more use downlink radio resources are allocated to the communication terminal 2 to which a large amount of data is to be transmitted. This achieves the effective use of the downlink radio resources.

In the present modification, when the number of communication terminals 2 for communication is not less than six, five communication terminals 2 are selected in descending order of the amount of data to be transmitted from the base station 1 from among the not less than six communication terminals 2, and the use uplink radio resources for SRS of 4 RBs are allocated from the first allocatable uplink radio resource 600a to each of the five communication terminals 2, whereas the use uplink radio resources for SRS of 4 RBs are allocated from the second allocatable uplink radio resource 600b to the remainder of the communication terminals 2. Thus, more use downlink radio resources are allocated to the communication terminal 2 to which a large amount of data is to be transmitted. This achieves the effective use of the downlink radio resources.

<Other Modifications>

The uplink radio resource (the first uplink radio resource for SRS 500a) identified by the first uplink communication period for SRS 370a and the subcarriers SC0 in the form of comb teeth which are included in the SRS transmittable band 450 and usable for the transmission of the SRS0, and the uplink radio resource (the second uplink radio resource for SRS 500b) identified by the second uplink communication period for SRS 370b and the subcarriers SC0 in the form of comb teeth which are included in the SRS transmittable band 450 and usable for the transmission of the SRS0 are used for the transmission of the SRS in the aforementioned example. In place of these uplink radio resources, an uplink radio resource (referred to hereinafter as a “fourth uplink radio resource for SRS”) identified by the first uplink communication period for SRS 370a and the subcarriers SC1 in the form of comb teeth which are included in the SRS transmittable band 450 and usable for the transmission of the SRS1, and the uplink radio resource (the third SRS uplink radio resource 500c) identified by the second uplink communication period for SRS 370b and the subcarriers SC1 in the form of comb teeth which are included in the SRS transmittable band 450 and usable for the transmission of the SRS 1 may be used. In this case, the first allocatable uplink radio resource for SRS 600a is set to the fourth uplink radio resource for SRS, and the second allocatable uplink radio resource for SRS 600b is set to the third uplink radio resources for SRS 500c.

Although the present invention is applied to LTE in the aforementioned examples, the present invention may be applied to other communication systems.

While the invention has been described in detail, the foregoing description is in all aspects illustrative and not restrictive. It is understood that numerous other modifications and variations which have not been illustrated can be devised without departing from the scope of the invention.

### REFERENCE SIGNS LIST

1 Base stations
2 Communication terminals
110a Antennas
122 Radio resource allocating section
360, 360a, 360b, 360c Unit periods
370a First uplink communication period for SRS
370a Second uplink communication period for SRS
600a First allocatable uplink radio resource for SRS
600b Second allocatable uplink radio resource for SRS
   601a Partial frequency band
   800a First downlink communication period
   800b Second downlink communication period
   800c Third downlink communication period

1. A base station for communicating with a communication terminal, comprising:
a communication section having a plurality of antennas and controlling the transmission directivity of the plurality of antennas, based on a known signal from a communication terminal, when performing downlink communication with the communication terminal; and
a radio resource allocating section for allocating a use downlink radio resource which said communication section uses for the downlink communication with a communication terminal to the communication terminal and for allocating, to a communication terminal, a use uplink radio resource for the known signal which the communication terminal uses for the transmission of the known signal,
wherein a unit period including a first uplink communication period in which a communication terminal transmits the known signal and a plurality of downlink communication periods in which downlink communication is performed appears repeatedly, the plurality of downlink communication periods appearing after the uplink communication period,
wherein a plurality of bandwidths different in magnitude from each other are determined as a bandwidth that can be set as a transmission frequency bandwidth of the known signal,
wherein said radio resource allocating section sets the transmission frequency bandwidth of the known signal transmitted from each communication terminal communicating with said communication section to the smallest one of the plurality of bandwidths, and
wherein said radio resource allocating section allocates, to a communication terminal which transmits the known signal in said first uplink communication period included in said unit period, a downlink radio resource including a frequency band included in the transmission frequency band of the known signal in a frequency direction and including said plurality of downlink communication periods included in the unit period in a time direction as said use downlink radio resource.

2. The base station according to claim 1,
wherein said unit period includes a second uplink communication period in which a communication terminal transmits the known signal, the second uplink communication period appearing before said plurality of downlink communication periods,
wherein first and second allocatable uplink radio resources for the known signal different in frequency band from each other and allocatable to a communication terminal as said use uplink radio resource for the known signal are determined respectively for two uplink radio resources including, in a time direction, said first uplink communication period and said second uplink communication period included in said unit period, and
wherein said radio resource allocating section allocates, to a communication terminal which transmits the known signal in said second uplink communication period included in said unit period, a downlink radio resource including a frequency band included in the transmission frequency band of the known signal in the frequency direction and including said plurality of downlink communication periods included in the unit period in the time direction as said use downlink radio resource.

3. The base station according to claim 2,
wherein said radio resource allocating section allocates said use uplink radio resource for the known signal from both of said first and second allocatable uplink radio resources for the known signal in said unit period to a communication terminal with which said communication section performs downlink communication in said unit period, when the number of communication terminals with which said communication section performs downlink communication is not more than the number of smallest bandwidths included in the frequency bandwidths of said first and second allocatable uplink radio resources for the known signal.

4. The base station according to claim 3,
wherein the frequency bands of said first and second allocatable uplink radio resources for the known signal change for each of said unit periods,
wherein the frequency band of said second allocatable uplink radio resource for the known signal in a leading one of two said consecutive unit periods is included in the frequency bands of said first and second allocatable uplink radio resources for the known signal in a trailing one thereof, and the frequency band of said first allocatable uplink radio resource for the known signal in the leading unit period includes a partial frequency band not included in the frequency bandwidths of said first and second allocatable uplink radio resources for the known signal in the trailing unit period, and
wherein said radio resource allocating section allocates a downlink radio resource including a frequency band included in the transmission frequency band of the known signal in the frequency direction and including said plurality of downlink communication periods included in a leading one of two said consecutive unit periods in the time direction as said use downlink radio resource and a downlink radio resource including a frequency band included in the transmission frequency band of the known signal in the frequency direction and including said plurality of downlink communication periods included in a trailing one thereof in the time direction as said use downlink radio resource to a communication terminal which transmits the known signal by using said use uplink radio resource for the known signal allocated from said first allocatable uplink radio resource for the known signal in the leading unit period and including a frequency band included in said partial frequency band in the frequency direction.

5. The base station according to claim 4,
wherein said radio resource allocating section determines whether said use uplink radio resource for the known signal is to be allocated to a communication terminal from said first allocatable uplink radio resource for the known signal or said second allocatable uplink radio resource for the known signal, based on the amount of data to be transmitted to the communication terminal.

6. A method of allocating a radio resource to a communication terminal in a base station communicating with the communication terminal by using a plurality of antennas and controlling the transmission directivity of the plurality of antennas, based on a known signal from the communication terminal, when performing downlink communication with the communication terminal, said method comprising the steps of:
(a) allocating a use downlink radio resource which said base station uses for the downlink communication with a communication terminal to the communication terminal; and
(b) allocating, to a communication terminal, a use uplink radio resource for the known signal which the communication terminal uses for the transmission of the known signal
wherein a unit period including an uplink communication period in which the communication terminal transmits the known signal and a plurality of downlink communication periods in which downlink communication is performed appears repeatedly, the plurality of downlink communication periods appearing after the uplink communication period,
wherein a plurality of bandwidths different in magnitude from each other are determined as a bandwidth that can be set as a transmission frequency bandwidth of the known signal,
wherein the transmission frequency bandwidth of the known signal transmitted from each communication terminal communicating with said base station is set to the smallest one of the plurality of bandwidths in said step (b), and
wherein a downlink radio resource including a frequency band included in the transmission frequency band of the known signal in a frequency direction and including said plurality of downlink communication periods included in the unit period in a time direction is allocated as said use downlink radio resource to a communication terminal which transmits the known signal in said uplink communication period included in said unit period in said step (a).
